(19) United States
(12) Patent Application Publication
(10) Pub. No.: US 2025/0364907 A1
(43) Pub. Date: Nov. 27, 2025

(54) VOLTAGE CONVERSION CIRCUIT

(71) Applicant: Zhuhai Nanxin Semiconductor Technology Co., Ltd., Zhuhai City (CN)

(72) Inventors: Mouzhao Zhou, Zhuhai City (CN); Jun Ma, Zhuhai City (CN)

(21) Appl. No.: 19/216,529

(22) Filed: May 22, 2025

(30) Foreign Application Priority Data
May 22, 2024 (CN) 202410643195.5
Aug. 15, 2024 (CN) 202411124359.X
Aug. 15, 2024 (CN) 202411124397.5

(51) Int. Cl. H02M 3/07; H02M 1/00; H02M 1/088

(52) U.S. Cl. CPC H02M 3/07; H02M 1/0003; H02M 1/088

(57) ABSTRACT

The present disclosure relates to the technical field of charge pumps, and in particular, relates to a voltage conversion circuit, a chip, a charge pump, and an electronic device. The voltage conversion circuit includes a first charge-discharge branch, a second charge-discharge branch, a third charge-discharge branch, a compensation resistor, a first current branch, and a second current branch. Introduction of a compensation resistor introduces a zero to the entire circuit, such that the voltage conversion circuit is substantially equivalent to a single-pole system, ensuring overall stability of the voltage conversion circuit.

### CROSS-REFERENCE TO RELATED APPLICATION

This application is based upon and claims the priority of Chinese Patent Application No. 202410643195.5, filed on May 22, 2024, Chinese Patent Application No. 202411124359.X, filed on Aug. 15, 2024, and Chinese Patent Application No. 202411124397.5, filed on Aug. 15, 2024. All of the aforementioned patent applications are hereby incorporated by reference in their entireties.

### TECHNICAL FIELD

The present disclosure relates to the technical field of charge pumps, and in particular, relates to a voltage conversion circuit, a chip, a charge pump, and an electronic device.

### BACKGROUND

A charge pump is a switched-mode converter that stores energy using capacitors, wherein switching transistors are employed to control the capacitors to are switched between a charge state and a discharge state, such that a supply voltage is boosted or bucked.

In the related art, a voltage conversion circuit for a charge pump typically includes a plurality of energy storage circuits and a plurality of charge circuits. Each of the charge circuits primarily includes a plurality of switches, and each of the energy storage circuits primarily includes a plurality of storage capacitors. Voltage at output terminals of the energy storage circuits, which are electrically connected to a load, are sampled. Then, based on the sampled voltages, the charge circuits are feedback-controlled to charge the energy storage circuits. Upon completion of charge, the energy storage circuits are controlled to discharge, such that a voltage at an output terminal of the voltage conversion circuit is stabilized at a target voltage. The voltage conversion circuit composed of various switching transistors and storage capacitors may be substantially equivalent to a three-pole circuit system. Due to the difficulty in compensating a three-pole circuit system, the stability of such a voltage conversion circuit is relatively poor.

### SUMMARY

Various embodiments of the present disclosure are intended to provide a voltage conversion circuit, a chip, a charge pump, and an electronic device to solve the technical problem of poor stability of the voltage conversion circuit.

In one aspect, the embodiments of the present disclosure provide a voltage conversion circuit. The voltage conversion circuit includes a first charge-discharge branch, a second charge-discharge branch, a third charge-discharge branch, a compensation resistor, a first current branch, and a second current branch.

The first charge-discharge branch, the second charge-discharge branch, and the third charge-discharge branch are sequentially connected in parallel, the compensation resistor is electrically connected in series in the third charge-discharge branch, an input terminal of the first charge-discharge branch is electrically connected to a power supply, and an output terminal of the third charge-discharge branch is electrically connected to a load.

The first current branch and the second current branch are respectively connected in series in the first charge-discharge branch and the second charge-discharge branch, and configured to supply charge currents to the first charge-discharge branch and the second charge-discharge branch respectively.
at least one transistor is arranged in each of the first charge-discharge branch, the second charge-discharge branch, the third charge-discharge branch, the first current branch, and the second current branch, wherein a control terminal of a transistor, which is one of the at least one transistor, is configured to receive a control signal to control a charge-discharge branch comprising the transistor to be turned on or turned off.

In some embodiments, the voltage conversion circuit further includes a fourth voltage sampling circuit.

The third charge-discharge branch includes a third capacitor.

The compensation resistor and the third capacitor are connected in series, a sampling terminal of the fourth voltage sampling circuit is configured to acquire a fourth voltage across a series connection of the compensation resistor and the third capacitor and output a charge current subsequent to performing logic processing on the fourth voltage, and an output terminal of the fourth voltage sampling circuit is electrically connected to an input terminal of the second current branch and configured to input the charge current to the second current branch.

In some embodiments, the first charge-discharge branch includes a first capacitor, and the second charge-discharge branch includes a second capacitor.

The voltage conversion circuit further includes a first voltage sampling circuit, a second voltage sampling circuit, and a third voltage sampling circuit.

The first voltage sampling circuit is configured to acquire a first voltage across the first capacitor, and output a first control signal subsequent to performing logic processing on the first voltage, wherein the first control signal is used to control the first current branch to be turned on or turned off.

The second voltage sampling circuit is configured to acquire a second voltage across the second capacitor, and output a second control signal subsequent to performing logic processing on the second voltage, wherein the second control signal is used to control the second current branch to be turned on or turned off.

The third voltage sampling circuit is configured to acquire a third voltage across the third capacitor, and output a third control signal subsequent to performing logic processing on the third voltage, wherein the third control signal is used to control the first charge-discharge branch, the second charge-discharge branch, the third charge-discharge branch, the first current branch, and the second current branch to be simultaneously turned on or turned off.

In some embodiments, each of the first voltage sampling circuit, the second voltage sampling circuit, and the third voltage sampling circuit includes a voltage acquisition module, a sample-and-hold circuit, and a comparator.

An input terminal of the voltage acquisition module is a voltage sampling terminal, an output of the voltage acquisition module is electrically connected to an input terminal of the sample-and-hold circuit, an output terminal of the sample-and-hold circuit is electrically connected to a non-inverting input terminal of the comparator, and an inverting input terminal of the comparator is configured to receive a reference voltage signal.

The voltage acquisition module is configured to acquire a corresponding voltage signal, the sample-and-hold circuit is configured to maintain a state of an acquired voltage signal, and the comparator is configured to output a corresponding control signal subsequent to performing logic processing on the acquired voltage signal and the reference voltage signal.

In some embodiments, the first charge-discharge branch further includes a first transistor and a third transistor, the second charge-discharge branch further includes a second transistor, and the third charge-discharge branch further includes a fourth transistor and a fifth transistor.

A first terminal of the first transistor is electrically connected to the power supply, a second terminal of the first transistor is electrically connected to a first terminal of the first capacitor, a second terminal of the first capacitor is electrically connected to an output terminal of the first current branch, a first terminal of the third transistor is electrically connected to the second terminal of the first capacitor, and a second terminal of the third transistor is electrically connected to the power supply.

A first terminal of the second transistor is electrically connected to the first terminal of the first capacitor, a second terminal of the second transistor is electrically connected to a first terminal of the second capacitor, and a second terminal of the second capacitor is electrically connected to an output terminal of the second current branch.

A first terminal of the fourth transistor is electrically connected to the first terminal of the second capacitor, a second terminal of the fourth transistor is electrically connected to a first terminal of the third capacitor via the compensation resistor, a first terminal of the fifth transistor is electrically connected to the second terminal of the second capacitor, a second terminal of the fifth transistor is electrically connected to a second terminal of the third capacitor, and two terminals of the third capacitor are electrically connected to a load.

Control terminals of the first transistor, the second transistor, the third transistor, the fourth transistor, and the fifth transistor are configured to receive their respective control signals, wherein the control signals are respectively used to control the first transistor, the second transistor, the third transistor, the fourth transistor, and the fifth transistor to be turned on or turned off.

In some embodiments, the first current branch includes a first current source, a sixth transistor, and a seventh transistor, wherein an input terminal of the first current source is configured to receive an analog voltage, and an output terminal of the first current source is electrically connected to a first terminal of the sixth transistor, a control terminal of the sixth transistor is electrically connected to a control terminal of the seventh transistor, a first terminal of the seventh transistor serves as an output terminal of the first current branch and is electrically connected to a second terminal of the first capacitor, the first terminal of the sixth transistor is further electrically connected to the control terminal of the seventh transistor, and both a second terminal of the sixth transistor and a second terminal of the seventh transistor are grounded.

The second current branch includes an eighth transistor and a ninth transistor, wherein a first terminal of the ninth transistor serves as the input terminal of the second current branch and is configured to receive a charge current output from the fourth voltage sampling circuit, a control terminal of the ninth transistor is electrically connected to a control terminal of the eighth transistor, a first terminal of the eighth transistor serves as an output terminal of the second current branch and is electrically connected to a second terminal of the second capacitor, a first terminal of the ninth transistor is electrically connected to the control terminal of the eighth transistor, and both a second terminal of the eighth transistor and a second terminal of the ninth transistor are grounded.

In some embodiments, the fourth voltage sampling circuit includes a voltage acquisition module and an error amplifier.

An input terminal of the voltage acquisition module serves as the sampling terminal of the fourth voltage sampling circuit, and an output terminal of the voltage acquisition module is electrically connected to a non-inverting input terminal of the error amplifier, an inverting input terminal of the error amplifier is configured to receive a reference voltage signal, an output terminal of the error amplifier serves as an output terminal of the fourth voltage sampling circuit and is electrically connected to the first terminal of the ninth transistor.

The voltage acquisition module is configured to acquire a fourth voltage across a series connection of the compensation resistor and the third capacitor, and the error amplifier is configured to amplify an error between the fourth voltage and the reference voltage signal and output a charge current to the second current branch.

In some embodiments, the voltage conversion circuit further includes a first drive circuit, a second drive circuit, a third drive circuit, a fourth drive circuit, and a fifth drive circuit, and the first charge-discharge branch further comprises a first transistor and a third transistor, the second charge-discharge branch further comprises a second transistor, and the third charge-discharge branch further comprises a fourth transistor and a fifth transistor.

An output terminal of the first drive circuit is electrically connected to a control terminal of the first transistor, an output terminal of the second drive circuit is electrically connected to a control terminal of the second transistor, an output terminal of the third drive circuit is electrically connected to a control terminal of the third transistor, an output terminal of the fourth drive circuit is electrically connected to a control terminal of the fourth transistor, and an output terminal of the fifth drive circuit is electrically connected to a control terminal of the fifth transistor.

Input terminals of the first drive circuit, the second drive circuit, the third drive circuit, the fourth drive circuit, and the fifth drive circuit are configured to receive their respective control signals respectively; and the first drive circuit, the second drive circuit, the third drive circuit, the fourth drive circuit, and the fifth drive circuit are configured to generate their respective switch drive signals based on the control signals respectively, wherein the switch drive signals are respectively used to control the first transistor, the second transistor, the third transistor, the fourth transistor, and the fifth transistor to be turned on or turned off.

In some embodiments, the error amplifier includes a tenth transistor, an eleventh transistor, a twelfth transistor, a thirteenth transistor, a fourteenth transistor, a fifteenth transistor, a sixteenth transistor, a seventeenth transistor, an eighteenth transistor, a nineteenth transistor, a twentieth transistor, a twenty-first transistor, a twenty-second transistor, a second current source, and a third current source.

A first terminal of the tenth transistor is configured to receive an analog voltage, a second terminal of the tenth transistor is electrically connected to a first terminal of the seventeenth transistor, a second terminal of the seventeenth transistor is electrically connected to an input terminal of the second current source, an output terminal of the second current source is grounded, a first terminal of the eleventh transistor is configured to receive the analog voltage, a second terminal of the eleventh transistor is electrically connected to a first terminal of the eighteenth transistor, a second terminal of the eighteenth transistor is electrically connected to the input terminal of the second current source, a control terminal of the tenth transistor is electrically connected to a control terminal of the eleventh transistor, a control terminal of the seventeenth transistor is electrically connected to an output terminal of the sample-and-hold circuit, and a control terminal of the eighteenth transistor is configured to receive the reference voltage signal.

A first terminal of the twelfth transistor is configured to receive the analog voltage, and a second terminal and a control terminal of the twelfth transistor are both connected to a second terminal of the eleventh transistor.

A first terminal of the thirteenth transistor is configured to receive the analog voltage, a second terminal of the thirteenth transistor is electrically connected to an input terminal of the third current source, an output terminal of the third current source is grounded, a control terminal of the thirteenth transistor is electrically connected to the second terminal of the eleventh transistor, a first terminal and a control terminal of the nineteenth transistor are both electrically connected to a second terminal of the thirteenth transistor, and a second terminal of the nineteenth transistor is grounded.

A first terminal of the fourteenth transistor is configured to receive the analog voltage, a second terminal of the fourteenth transistor is electrically connected to a first terminal of the twentieth transistor, a control terminal of the fourteenth transistor is electrically connected to the second terminal of the eleventh transistor, a second terminal of the twentieth transistor is grounded, a control terminal of the twentieth transistor is electrically connected to the second terminal of the thirteenth transistor, a first terminal of the twenty-first transistor is electrically connected to a second terminal of the fourteenth transistor, a second terminal of the twenty-first transistor is grounded, a control terminal of the twenty-first transistor is electrically connected to a control terminal of the twenty-second transistor, and the control terminal of the twenty-first transistor is further electrically connected to the first terminal of the twenty-first transistor.

A first terminal of the fifteenth transistor is configured to receive the analog voltage, a second terminal of the fifteenth transistor is electrically connected to a first terminal of the twenty-second transistor, a control terminal of the fifteenth transistor is electrically connected to a control terminal of the sixteenth transistor, the control terminal of the fifteenth transistor is further electrically connected to the second terminal of the fifteenth transistor, and a second terminal of the twenty-second transistor is grounded.

A first terminal of the sixteenth transistor is configured to receive the analog voltage, and a second terminal of the sixteenth transistor is configured to output the charge current.

In some embodiments, the voltage conversion circuit further includes a control chip, wherein the control chip includes a plurality of enable terminals, wherein the plurality of enable terminals are respectively electrically connected to the input terminals of the first drive circuit, the second drive circuit, the third drive circuit, the fourth drive circuit, and the fifth drive circuit; and The control chip is configured to, under dual-phase non-overlapping clock signals, output respective control signals to drive corresponding drive circuits to generate their respective switch drive signals respectively.

In a second aspect, the embodiments of the present disclosure further provide a charge pump. The charge pump includes the voltage conversion circuit as described above.

In some embodiments, the charge pump further includes a logic control circuit; wherein the logic control circuit includes a plurality of enable terminals, wherein the plurality of enable terminals are respectively electrically connected to the input terminals of the first drive circuit, the second drive circuit, the third drive circuit, the fourth drive circuit, and the fifth drive circuit.

The logic control chip is configured to, under dual-phase non-overlapping clock signals, output respective control signals to control corresponding drive circuits to generate their respective switch drive signals.

In a third aspect, the embodiments of the present disclosure further provide a chip. The chip includes the voltage conversion circuit as described above or the charge pump as described above.

In a fourth aspect, the embodiments of the present disclosure further provide an electronic device. The electronic device includes the chip as described above.

In a fifth aspect, the embodiments of the present disclosure further provide a voltage conversion circuit applicable to a charge pump. The voltage conversion circuit includes a first energy storage circuit, a second energy storage circuit, a third energy storage circuit, a first charge circuit, a second charge circuit, a first charge control circuit, and a second charge control circuit.

The first energy storage circuit, the second energy storage circuit, and the third energy storage circuit are connected in parallel, a first terminal of the first energy storage circuit is electrically connected to a first power supply, and two terminals of the third energy storage circuit are electrically connected to a load.

The first energy storage circuit includes a first energy store, and the second energy storage circuit includes a second energy store, wherein the first energy store and the second energy store are both configured to store energy.

The first charge control circuit is configured to acquire a first voltage across the first energy store and generate a first charge control signal based on the first voltage, and the second charge control circuit is configured to acquire a second voltage across the second energy store and generate a second charge control signal based on the second voltage.

The first charge control signal is used to control the first charge circuit to be turned on or turned off, and the second charge control signal is used to control the second charge circuit to be turned on or turned off.

The first charge circuit in an on state is configured to output a first charge current to the first energy storage circuit, and the second charge circuit in an on state is configured to output a second charge current to the second energy storage circuit.

The first energy storage circuit, the second energy storage circuit, and the third energy storage circuit are configured to receive their respective switch drive signals respectively, wherein the switch drive signals are used to respectively control the first energy storage circuit, the second energy storage circuit, and the third energy storage circuit to be turned on or turned off, such that the first energy storage circuit, the second energy storage circuit, and the third energy storage circuit are switched between a charge state and a discharge state respectively.

In some embodiments, the third energy storage circuit includes a third energy storage, wherein the third energy storage is configured to store energy.

The voltage conversion circuit further includes a third charge control circuit.

The third charge control circuit is configured to acquire a third voltage across the third energy store and generate a third charge control signal based on the third voltage.

The third charge control signal is used to control the first charge circuit and the second charge circuit to be simultaneously turned on or turned off.

In some embodiments, the first charge control signal includes a first charge enable signal and a first charge disable signal, wherein the first charge enable signal is used to control the first charge circuit to be turned on, and the first charge disable signal is used to control the first charge circuit to be turned off.

The first charge control circuit is configured to generate the first charge enable signal in response to the first voltage being less than a first predetermined value, and generate the first charge disable signal in response to the first voltage being greater than a second predetermined value.

The second charge control signal includes a second charge enable signal and a second charge disable signal, wherein the second charge enable signal is used to control the second charge circuit to be turned on, and the second charge disable signal is used to control the second charge circuit to be turned off.

The second charge control circuit is configured to generate the second charge enable signal in response to the second voltage being less than the first predetermined value, and generate the second charge disable signal in response to the second voltage being greater than the second predetermined value.

The third charge control signal includes a third charge enable signal and a third charge disable signal, wherein the third charge enable signal is used to control the first charge circuit and the second charge circuit to be simultaneously turned on, and the third charge disable signal is used to control the first charge circuit and the second charge circuit to be simultaneously turned off.

The third charge control circuit is configured to generate the third charge enable signal in response to the third voltage being less than the first predetermined value, and generate the third charge disable signal in response to the third voltage being greater than the second predetermined value.

The first predetermined threshold is less than the second predetermined threshold.

In some embodiments, the first charge circuit includes a first current source, a first transistor, a second transistor, a third transistor, and a fourth transistor.

A positive terminal of the first current source is electrically connected to a second power supply, a negative terminal of the first current source is electrically connected to a first terminal of the first transistor, a second terminal of the first transistor is electrically connected to a first terminal of the third transistor, a second terminal of the third transistor is grounded, a control terminal of the third transistor is electrically connected to a control terminal of the fourth transistor, a first terminal of the fourth transistor is electrically connected to a second terminal of the first energy store, a second terminal of the fourth transistor is grounded, a first terminal of the second transistor is electrically connected to a second terminal of the first transistor, a second terminal of the second transistor is grounded, a control terminal of the first transistor and a control terminal of the second transistor are both configured to receive the first charge control signal and the third charge control signal.

The second charge circuit includes a second current source, a fifth transistor, a sixth transistor, a seventh transistor, and an eighth transistor.

A positive terminal of the second current source is electrically connected to the second power supply, a negative terminal of the second current source is electrically connected to a first terminal of the fifth transistor, a second terminal of the fifth transistor is electrically connected to a first terminal of the seventh transistor, a second terminal of the seventh transistor is grounded, a control terminal of the seventh transistor is electrically connected to a control terminal of the eighth transistor, a first terminal of the eighth transistor is electrically connected to a second terminal of the second energy store, a second terminal of the eighth transistor is grounded, a first terminal of the sixth transistor is electrically connected to a second terminal of the fifth transistor, a second terminal of the sixth transistor is grounded, a control terminal of the fifth transistor and a control terminal of the sixth transistor are both configured to receive the second charge control signal and the third charge control signal.

In some embodiments, the first energy store is a first capacitor, and the first energy storage circuit further includes a ninth transistor and a tenth transistor; wherein a first terminal of the ninth transistor serves as the first terminal of the first energy storage circuit, a second terminal of the ninth transistor is electrically connected to a first terminal of the first capacitor, a second terminal of the first capacitor serves as a second terminal of the first energy storage circuit, a second terminal of the first capacitor is further electrically connected to a first terminal of the tenth transistor, a second terminal of the tenth transistor is electrically connected to the first power supply, and the second terminal of the first capacitor is further electrically connected to an output terminal of the first charge circuit.

The second energy store is a second capacitor, and the second energy storage circuit further includes an eleventh transistor; wherein a first terminal of the eleventh transistor is electrically connected to the first terminal of the first capacitor, a second terminal of the eleventh transistor is electrically connected to a first terminal of the second capacitor, and a second terminal of the second capacitor is electrically connected to an output terminal of the second charge circuit.

The third energy store is a third capacitor, and the third energy storage circuit further includes a twelfth transistor and a thirteenth transistor; wherein a first terminal of the twelfth transistor is electrically connected to the first terminal of the second capacitor, a second terminal of the twelfth transistor is electrically connected to a first terminal of the third capacitor, a second terminal of the third capacitor is electrically connected to a second terminal of the thirteenth transistor, a first terminal of the thirteenth transistor is electrically connected to the second terminal of the second capacitor, and the first terminal and the third terminal of the third capacitor form an output terminal of the third energy storage circuit.

Control terminals of the ninth transistor, the tenth transistor, the eleventh transistor, a control terminal of the twelfth transistor, and the thirteenth transistor are configured to receive their respective switch drive signals, wherein the switch drive signals are respectively used to control the ninth transistor, the tenth transistor, the eleventh transistor, the twelfth transistor, and the thirteenth transistor to be turned on or turned off.

In some embodiments, the first energy storage circuit further includes a first resistor and a second resistor, wherein the second terminal of the ninth transistor is electrically connected to a first terminal of the first resistor, a second terminal of the first resistor is electrically connected to the first terminal of the first capacitor, the second terminal of the tenth transistor is electrically connected to a first terminal of the second resistor, and a second terminal of the second resistor is electrically connected to the first power supply.

The second energy storage circuit further includes a third resistor, wherein the first terminal of the eleventh transistor is electrically connected to a first terminal of the third resistor, and a second terminal of the third resistor is electrically connected to the first terminal of the second capacitor.

The third energy storage circuit further includes a fourth resistor and a fifth resistor, wherein the second terminal of the twelfth transistor is electrically connected to a first terminal of the fourth resistor, a second terminal of the fourth resistor is electrically connected to the first terminal of the third capacitor, the second terminal of the third capacitor is electrically connected to a first terminal of the fifth resistor, and a second terminal of the fifth resistor is electrically connected to the second terminal of the thirteenth transistor.

In some embodiments, the first charge control circuit includes a first voltage sampling circuit and a first hysteresis comparator circuit, wherein the first voltage sampling circuit is configured to sample the first voltage across the first energy store, and the first hysteresis comparator circuit is configured to compare the first voltage with a corresponding predetermined value and generate the first charge control signal based on a comparison result thereof.

The second charge control circuit includes a second voltage sampling circuit and a second hysteresis comparator circuit, wherein the second voltage sampling circuit is configured to sample the second voltage across the second energy storage device, and the second hysteresis comparator circuit is configured to compare the second voltage with a corresponding predetermined value and generate the second charge control signal based on a comparison result thereof.

The third charge control circuit includes a third voltage sampling circuit and a third hysteresis comparator circuit, wherein the third voltage sampling circuit is configured to sample the third voltage across the third energy store, and the second hysteresis comparator circuit is configured to compare the second voltage with a corresponding predetermined value and generate the third charge control signal based on a comparison result thereof.

In some embodiments, the first voltage sampling circuit, the second voltage sampling circuit, and the third voltage sampling circuit have a same circuit structure, and the first hysteresis comparator circuit, the second hysteresis comparator circuit, and the third hysteresis comparator circuit have a same circuit structure.

The first voltage sampling circuit includes a fourteenth transistor, a fifteenth transistor, a sixteenth transistor, a seventeenth transistor, an eighteenth transistor, a nineteenth transistor, and a fifth resistor.

A first terminal of the fourteenth transistor is electrically connected to a first terminal of the first energy store, a second terminal of the fourteenth transistor is electrically connected to a first terminal of the fifteenth transistor, a second terminal of the fifteenth transistor is electrically connected to a first terminal of the sixteenth transistor, a second terminal of the sixteenth transistor is electrically connected to a second terminal of the first energy store, a control terminal and the second terminal of the fourteenth transistor are short-circuited, a control terminal and the second terminal of the fifteenth transistor are short-circuited, and a control terminal and the second terminal of the sixteenth transistor are short-circuited.

A first terminal of the seventeenth transistor is electrically connected to the first terminal of the first energy store, a second terminal of the seventeenth transistor is electrically connected to a first terminal of the fifth resistor, a second terminal of the fifth resistor is electrically connected to a second terminal of the first energy store, and a control terminal and a second terminal of the seventeenth transistor are short-circuited.

A first terminal of the eighteenth transistor is electrically connected to the first terminal of the seventeenth transistor, a control terminal of the eighteenth transistor is electrically connected to the control terminal of the seventeenth transistor, a second terminal of the eighteenth transistor is electrically connected to a first terminal of the nineteenth transistor, a control terminal of the nineteenth transistor is electrically connected to the control terminal of the sixteenth transistor, and a second terminal of the nineteenth transistor serves as an output terminal of the first voltage sampling circuit.

The first hysteresis comparator circuit includes a twentieth transistor, a twenty-first transistor, a twenty-second transistor, a twenty-third transistor, a sixth resistor, a seventh resistor, a fourth capacitor, a comparator, and an inverter.

A first terminal of the twentieth transistor is electrically connected to the output terminal of the first voltage sampling circuit, the first terminal and a control terminal of the twentieth transistor are short-circuited, a second terminal of the twentieth transistor is electrically connected to a first terminal of the twenty-first transistor, the first terminal and a control terminal of the twenty-first transistor are short-circuited, a second terminal of the twenty-first transistor is electrically connected to a first terminal of the twenty-second transistor, the first terminal and a control terminal of the twenty-second transistor are short-circuited, and a second terminal of the twenty-second transistor is grounded.

A first terminal of the sixth resistor is electrically connected to the output terminal of the first voltage sampling circuit, a second terminal of the sixth resistor is electrically connected to a first terminal of the seventh resistor, a second terminal of the seventh resistor is grounded, the first terminal of the sixth resistor is electrically connected to a non-inverting input terminal of the comparator, an inverting input terminal of the comparator is configured to receive a predetermined value, and an output terminal of the comparator serves as an output terminal of the first hysteresis comparator circuit and is configured to output the first charge control signal.

A first terminal of the fourth capacitor is electrically connected to the non-inverting input terminal of the comparator, a second terminal of the fourth capacitor is grounded, a first terminal of the twenty-third transistor is electrically connected to the first terminal of the seventh resistor, a second terminal of the twenty-third transistor is electrically connected to the second terminal of the seventh resistor, the output terminal of the comparator is electrically connected to an input terminal of the inverter, and an output terminal of the inverter is electrically connected to a control terminal of the twenty-third transistor.

In some embodiments, the first voltage sampling circuit further includes an eighth resistor and a ninth resistor.

The second terminal of the sixteenth transistor is electrically connected to a first terminal of the eighth resistor, and a second terminal of the eighth resistor is electrically connected to the second terminal of the first energy store.

The first terminal of the sixth resistor is electrically connected to a first terminal of the ninth resistor, and a second terminal of the ninth resistor is electrically connected to the non-inverting input terminal of the comparator.

In some embodiments, the voltage conversion circuit further includes an electromagnetic interference eliminating circuit, configured to eliminate electromagnetic interference signals in the first energy storage circuit, the second energy storage circuit, and the third energy storage circuit.

The electromagnetic interference eliminating circuit includes a first output terminal and a second output terminal, wherein the first output terminal of the electromagnetic interference eliminating circuit is electrically connected to the second terminal of the first energy store, and the second output terminal of the electromagnetic interference eliminating circuit is electrically connected to the second terminal of the second energy store.

In some embodiments, the electromagnetic interference eliminating circuit includes a twenty-fourth transistor, a twenty-fifth transistor, a twenty-sixth transistor, a twenty-seventh transistor, a twenty-eighth transistor, a twenty-ninth transistor, a thirtieth transistor, a thirty-first transistor, a third current source, and a fourth current source.

A positive terminal of the third current source is electrically connected to the second power supply, a negative terminal of the third current source is electrically connected to a first terminal of the twenty-fourth transistor, a second terminal of the twenty-fourth transistor is electrically connected to a first terminal of the twenty-fifth transistor, the first terminal and a control terminal of the twenty-fifth transistor are short-circuited, a second terminal of the twenty-fifth transistor is grounded, a first terminal of the twenty-sixth transistor serves as the first output terminal of the electromagnetic interference eliminating circuit, a second terminal of the twenty-sixth transistor is grounded, a control terminal of the twenty-sixth transistor is electrically connected to a control terminal of the twenty-fifth transistor, a first terminal of the twenty-seventh transistor is electrically connected to the second terminal of the twenty-fourth transistor, a second terminal of the twenty-seventh transistor is grounded, and a control terminal of the twenty-fourth transistor and a control terminal of twenty-seventh transistor are both configured to receive a fourth charge control signal, wherein the fourth charge control signal is used to control the twenty-fourth transistor and the twenty-seventh transistor to be turned on or turned off simultaneously.

A positive terminal of the fourth current source is electrically connected to the second power supply, a negative terminal of the fourth current source is electrically connected to a first terminal of the twenty-eighth transistor, a second terminal of the twenty-eighth transistor is electrically connected to a first terminal of the twenty-ninth transistor, the first terminal and a control terminal of the twenty-ninth transistor are short-circuited, a second terminal of the twenty-ninth transistor is grounded, a first terminal of the thirty-first transistor serves as the second output terminal of the electromagnetic interference eliminating circuit, a second terminal of the thirty-first transistor is grounded, a control terminal of the thirty-first transistor is electrically connected to the control terminal of the twenty-ninth transistor, a first terminal of the thirtieth transistor is electrically connected to the second terminal of the twenty-eighth transistor, a second terminal of the thirtieth transistor is grounded, and a control terminal of the twenty-eighth transistor and a control terminal of the thirtieth transistor are both configured to receive a fifth charge control signal, wherein the fifth charge control signal is used to control the twenty-eighth transistor and the thirtieth transistor to be simultaneously turned on or turned off.

In some embodiments, the voltage conversion circuit further includes a first drive circuit, a second drive circuit, a third drive circuit, a fourth drive circuit, and a fifth drive circuit.

The first drive circuit, the second drive circuit, the third drive circuit, the fourth drive circuit, and the fifth drive circuit are configured to receive their respective switch control signals respectively, and generate their respective switch drive signals based on the switch control signals respectively, wherein the switch drive signals are used to respectively control the ninth transistor, the tenth transistor, the eleventh transistor, the twelfth transistor, and the thirteenth transistor to be turned on or turned off.

In a sixth aspect, the embodiments of the present disclosure further provide a charge pump. The charge pump includes the voltage conversion circuit as described above.

In some embodiments, the charge pump further includes a logic control circuit.

The logic control chip includes a plurality of enable terminals, wherein the plurality of enable terminals are respectively electrically connected to the input terminals of the first drive circuit, the second drive circuit, the third drive circuit, the fourth drive circuit, and the fifth drive circuit, and the logic control circuit is configured to, under dual-phase non-overlapping clock signals, output corresponding control signals to control the drive circuits to generate their respective switch drive signals respectively.

In a seventh aspect, the embodiments of the present disclosure further provide a chip. The chip includes the voltage conversion circuit as described above or the charge pump as described above.

In an eighth aspect, the embodiments of the present disclosure further provide an electronic device. The electronic device includes the chip as described above.

In a ninth aspect, the embodiments of the present disclosure further provide a voltage conversion circuit applicable to a charge pump. The voltage conversion circuit includes a first energy storage circuit, a second energy storage circuit, a third energy storage circuit, a first charge circuit, a second charge circuit, and a first feedback control circuit.

The first energy storage circuit, the second energy storage circuit, and the third energy storage circuit are connected in parallel, a first terminal of the first energy storage circuit is electrically connected to a power supply, and two terminals of the third energy storage circuit are electrically connected to a load.

The first charge circuit is configured to supply a first charge current to the first energy storage circuit, and the second charge circuit is configured to supply a second charge current to the second energy storage circuit.

The first charge circuit and the second charge circuit are configured to receive their respective switch control signals respectively, wherein the switch control signals are used to control the first charge circuit and the second charge circuit to be turned on or turned off respectively; and the first energy storage circuit, the second energy storage circuit, and the third energy storage circuit are configured to receive their respective switch drive signals respectively, wherein the switch drive signals are respectively used to control the first energy storage circuit, the second energy storage circuit, and the third energy storage circuit to be turned on or turned off, such that the first energy storage circuit, the second energy storage circuit, and the third energy storage circuit are respectively controlled to are switched between a charge state and a discharge state.

The first feedback control circuit is configured to acquire a first voltage at an output terminal of the third energy storage circuit in a case where the third energy storage circuit is in a charge state, and adjust magnitudes of the first charge current and the second charge current based on the first voltage.

The first feedback control circuit includes a first zero-order hold, configured to maintain a voltage at the output terminal of the third energy storage circuit to be the first voltage in a case where the third energy storage circuit is in a discharge state.

In some embodiments, the third energy storage circuit includes a compensation resistor and a third capacitor.

A first terminal of the second energy storage circuit is electrically connected to a first terminal of the compensation resistor.

A second terminal of the compensation resistor is electrically connected to a first terminal of the third capacitor, and a second terminal of the third capacitor is electrically connected to a second terminal of the second energy storage circuit.

The first feedback control circuit is configured to acquire a voltage between the first terminal of the compensation resistor and the second terminal of the third capacitor as the first voltage.

In some embodiments, each of the first energy storage circuit, the second energy storage circuit, the third energy storage circuit, the first charge circuit, the second charge circuit includes at least one transistor.

A transistor, which is one of the at least one transistor, is configured to receive a corresponding switch control signal, wherein the switch control signal is used to control the transistor to be turned on or turned off, such that an energy storage circuit comprising the transistor is controlled to be turned on or turned off.

In some embodiments, the first charge circuit includes a first transistor, a second transistor, and a third transistor.

A first terminal of the first transistor is configured to receive a first current control signal, wherein the first current control signal is used to control the first charge circuit to adjust a magnitude of the first charge current; a second terminal of the first transistor is grounded, the first terminal and a control terminal of the first transistor are short-circuited, and the control terminal of the first transistor is electrically connected to a control terminal of the second transistor; a first terminal of the second transistor is electrically connected to a second terminal of the third transistor, and a second terminal of the second transistor is grounded; and a first terminal of the third transistor is electrically connected to a second terminal of the first energy storage circuit, and the first terminal of the first energy storage circuit is configured to be connected to the power supply.

The second charge circuit includes a fourth transistor, a fifth transistor and a sixth transistor.

A first terminal of the fourth transistor is configured to receive a second current control signal, wherein the second current control signal is used to control the second charge circuit to adjust a magnitude of the second charge current; a second terminal of the fourth transistor is grounded, the first terminal and a control terminal of the fourth transistor are short-circuited, and the control terminal of the fourth transistor is electrically connected to a control terminal of the fifth transistor; a second terminal of the fifth transistor is grounded, a first terminal of the fifth transistor is electrically connected to a second terminal of the sixth transistor, and a first terminal of the sixth transistor is electrically connected to one terminal of the second energy storage circuit.

A control terminal of the third transistor and a control terminal of the sixth transistor are configured to receive their respective switch control signals respectively, wherein the switch control signals are respectively used to control the third transistor and the sixth transistor to be turned on or turned off.

A withstand voltage of the third transistor is greater than withstand voltages of the first transistor and the second transistor, and a withstand voltage of the sixth transistor is greater than withstand voltages of the fourth transistor and the fifth transistor.

In some embodiments, the withstand voltages of the third transistor and the sixth transistor are not less than a voltage of the power supply.

In some embodiments, the first feedback control circuit further includes a first voltage sampling circuit and a first error amplifier.

The first voltage sampling circuit is configured to acquire the first voltage at the output terminal of the third energy storage circuit in a case where the third energy storage circuit is in the charge state.

The first zero-order hold is configured to maintain the first voltage output by the first energy storage circuit in a case where the third energy storage circuit is in the discharge state.

The first error amplifier is configured to compare the first voltage with a first reference voltage to obtain a comparison result, and generate a first current control signal and a second current control signal based on the comparison result.

The first current control signal is used to control the first charge circuit to adjust a magnitude of the first charge current, and the second current control signal is used to control the second charge circuit to adjust a magnitude of the second charge voltage.

In some embodiments, a bandwidth of the first voltage sampling circuit is less than ¼ of a sampling clock frequency.

In some embodiments, the first energy storage circuit includes a first capacitor, and the second energy storage circuit includes a second capacitor.

The first energy storage circuit further includes a seventh transistor and an eighth transistor, wherein a first terminal of the seventh transistor serves as the first terminal of the first energy storage circuit, a second terminal of the seventh transistor is electrically connected to a first terminal of the first capacitor, a second terminal of the first capacitor serves as a second terminal of the first energy storage circuit, a second terminal of the first capacitor is further electrically connected to a first terminal of the seventh transistor, and a second terminal of the eighth transistor is electrically connected to the power supply.

The second energy storage circuit further includes a ninth transistor, wherein a first terminal of the ninth transistor serves as the first terminal of the second energy storage circuit, a second terminal of the ninth transistor is electrically connected to a first terminal of the second capacitor, and a second terminal of the second capacitor serves as the second terminal of the second energy storage circuit.

The third energy storage circuit further includes a tenth transistor and an eleventh transistor, wherein a first terminal of the tenth transistor is electrically connected to the first terminal of the second capacitor, a second terminal of the tenth transistor is electrically connected to a first terminal of the third capacitor, a second terminal of the third capacitor is electrically connected to a second terminal of the eleventh transistor, a first terminal of the eleventh transistor is electrically connected to the second terminal of the second capacitor, and the first terminal and the second terminal of the third capacitor form an output terminal of the third energy storage circuit.

A control terminal of the seventh transistor, a control terminal of the eighth transistor, a control terminal of the ninth transistor, a control terminal of the tenth transistor, and a control terminal of the eleventh transistor are configured to receive their respective switch drive signals respectively, wherein the switch drive signals are respectively used to control the seventh transistor, the eighth transistor, the ninth transistor, the tenth transistor, and the eleventh transistor to be turned on or turned off.

In some embodiments, the voltage conversion circuit further includes a first drive circuit, a second drive circuit, a third drive circuit, a fourth drive circuit, and a fifth drive circuit.

The first drive circuit, the second drive circuit, the third drive circuit, the fourth drive circuit, and the fifth drive circuit are configured to receive the their respective switch control signals respectively, and generate their respective switch drive signals based on the switch control signals respectively, wherein the switch drive signals are used to respectively control the seventh transistor, the eighth transistor, the ninth transistor, the tenth transistor, and the eleventh transistor to be turned on or turned off.

In a tenth aspect, the embodiments of the present disclosure further provide a charge pump. The charge pump includes the voltage conversion circuit as described above.

In some embodiments, the charge pump further includes a logic control circuit.

The logic control chip includes a plurality of enable terminals, wherein the plurality of enable terminals are respectively electrically connected to the input terminals of the first drive circuit, the second drive circuit, the third drive circuit, the fourth drive circuit, and the fifth drive circuit.

The logic control chip is configured to, under dual-phase non-overlapping clock signals, output their respective control signals to control corresponding drive circuits to generate their respective switch drive signals.

In an eleventh aspect, the embodiments of the present disclosure further provide a chip. The chip includes the voltage conversion circuit as described above or the charge pump as described above.

In a twelfth aspect, the embodiments of the present disclosure further provide an electronic device. The electronic device includes the chip as described above.

The voltage conversion circuit according to the embodiments of the present disclosure includes a first charge-discharge circuit, a second charge-discharge circuit, a third charge-discharge circuit, a compensation resistor, a first current branch, and a second current branch. The first charge-discharge branch, the second charge-discharge branch, and the third charge-discharge branch are sequentially connected in parallel, and the compensation resistor is electrically connected in series in the third charge-discharge branch. An input terminal of the first charge-discharge branch is electrically connected to a power supply, and an output terminal of the third charge-discharge branch is electrically connected to a load. The first current branch and the second current branch are respectively connected in series in the first charge-discharge branch and the second charge-discharge branch, and configured to supply charge currents to the first charge-discharge branch and the second charge-discharge branch respectively. At least one transistor is arranged in each of the first charge-discharge branch, the second charge-discharge branch, the third charge-discharge branch, the first current branch, and the second current branch, wherein a control terminal of the transistor is configured to receive a control signal to control a corresponding branch to be turned on or turned off. Apparently, the voltage conversion circuit according to the present disclosure introduces the compensation resistor and thus introduces a zero to the entire circuit, such that the voltage conversion circuit is substantially equivalent to a single-pole system. Therefore, overall stability of the voltage conversion circuit is ensured.

In the voltage conversion circuit according to the present disclosure, by acquiring voltages across both a first energy store and a second energy store, and respective charge control signals based on the acquired voltages are generated, to control a first charge circuit and a second charge circuit to be turned on or turned off. In this way, a first energy storage circuit, a second energy storage circuit, and a third energy storage circuit are controlled to are switched between a charge state and a discharge state, such that the voltage at the output terminal of the voltage conversion circuit is stabilized (maintained) at a target value or within a target value range.

In the voltage conversion circuit according to the present disclosure, within each operating period, the voltage at the output terminal of the third energy storage circuit is acquired only in a case where the third energy storage circuit is in the charge state; whereas the voltage at the output terminal of the third energy storage circuit does not need to be continuously acquired in a case where the third energy storage circuit is in the discharge state, and instead, the first voltage acquired in a case where the third energy storage circuit is in the discharge state is maintained by the zero-order hold function of the first zero-order hold. In this way, the third energy storage circuit is prevented from generating large ripples during switching between the charge state and the discharge state, such that accuracy of the acquired first voltage is not affected and thus accuracy of the first charge current and the second charge current is not affected. Ultimately, stability of the circuit is ensured.

### BRIEF DESCRIPTION OF THE DRAWINGS

FIG. 1 is a schematic structural diagram of a voltage conversion circuit in the related art;

FIG. 2 is a schematic structural diagram of a voltage sampling circuit in the related art;

FIG. 3 is a schematic diagram of a clock signal waveform in the related art;

FIG. 4 is a schematic structural diagram of an equivalent linear model for a voltage conversion circuit in the related art;

FIG. 5 is a Bode plot of an equivalent linear model for an output stage of a voltage conversion circuit in the related art;

FIG. 6 is a schematic structural diagram of a voltage conversion circuit according to some embodiments of the present disclosure;

FIG. 7 is a schematic structural diagram of a voltage sampling circuit according to some embodiments of the present disclosure;

FIG. 8 is a schematic structural diagram illustrating a circuit structure of an error amplifier according to some embodiments of the present disclosure;

FIG. 9 is a schematic diagram of an equivalent linear model for an output stage of a voltage conversion circuit according to some embodiments of the present disclosure;

FIG. 10 is a Bode plot of an equivalent linear model according to some embodiments of the present disclosure;

FIG. 11 is a schematic structural diagram of a voltage conversion circuit in the related art;

FIG. 12 is a schematic structural diagram of a charge control circuit in the related art;

FIG. 13 is a schematic structural diagram of a voltage conversion circuit according to some embodiments of the present disclosure;

FIG. 14 is a schematic structural diagram of a charge control circuit according to some embodiments of the present disclosure;

FIG. 15 is a schematic structural diagram of a first charge control circuit according to some embodiments of the present disclosure;

FIG. 16 is a schematic structural diagram of an electromagnetic interference suppression circuit according to some embodiments of the present disclosure;

FIG. 17 is a schematic structural diagram of a voltage conversion circuit according to some embodiments of the present disclosure;

FIG. 18 is a schematic structural diagram of a first feedback control circuit according to some embodiments of the present disclosure;

FIG. 19 is a schematic structural diagram of an equivalent linear model for a voltage conversion circuit in the related art;

FIG. 20 is a Bode plot of an equivalent linear model for an output stage of a voltage conversion circuit in the related art;

FIG. 21 is a Bode plot of an equivalent linear model for a voltage conversion circuit according to some embodiments of the present disclosure;

FIG. 22 is a schematic diagram of a sample-and-hold feedback system of a first sample-and-hold system according to some embodiments of the present disclosure; and

FIG. 23 is a schematic diagram of a zero-order sample-and-hold feedback system of a first sample-and-hold system based in a single-pole system according to some embodiments of the present disclosure.

### DETAILED DESCRIPTION

It should be understood that the specific embodiments described herein are only intended to explain the present disclosure instead of limiting the present disclosure.

In the present disclosure, the term “at least one” refers to one or more than one, and the term “a plurality of” refers to two or more than two. The term “and/or” is merely an association relationship for describing associated objects, which represents that there may exist three types of relationships. For example, the phrase “A and/or B” means (A), (B), or (A and B), wherein A and B may be single or plural. In addition, the symbol “/” generally represents an “or” relationship between associated objects before and after the symbol. The expression “at least one of the following” or the like expression means any combination of the items or options listed, including a single item or option or any combination of plural items or options listed. For example, at least one of a single a, a single b, and a single c may indicate: the single a, the single b, the single c, a combination of a and b, a combination of a and c, a combination of b and c, or a combination of a, b, and c, wherein each of a, b, and c may be single or plural. In addition, the terms “first,” “second,” and the like are merely for the illustration purpose, and shall not be construed as indicating or implying a relative importance.

In the description of the present disclosure, it should be understood that the terms “central,” “transversal,” “longitudinal,” “upper,” “lower,” “left,” “right,” “front,” “rear,” and the like indicate orientations and position relationships which are based on the illustrations in the accompanying drawings, and these terms are merely for ease and brevity of the description, instead of indicating or implying that the devices or elements shall have a particular orientation and shall be structured and operated based on the particular orientation. Accordingly, these terms shall not be construed as limiting the present disclosure.

In the description of the present disclosure, unless otherwise explicitly specified and defined, the terms “connected,” “coupled,” and derivatives forms thereof shall be understood in a broad sense. For example, the terms “connected,” “coupled,” and derivatives form thereof for depicting the circuit structure, in addition to physical connection, may also be understood as electrical connections or signal connection. The connection, for example, may be direct connection, i.e., the physical connection or, indirect connection via at least one intermediate element as long as the circuit is turned on, or communication between the interiors of two elements. The signal connection, in addition to signal connection via a circuitry, may also be signal connection via a communication medium, for example, radio waves. Persons of ordinary skill in the art may understand specific meanings of the above terms in the present disclosure according to the actual circumstances and contexts.

The transistors according to the embodiments of the present disclosure are all three-terminal transistors. For example, each of the transistors has a control terminal, a first terminal, and a second terminal. The transistors may be bipolar transistors or field-effect transistors. For example, in a case where the transistor is a bipolar transistor, the control terminal of the transistor refers to a base of the bipolar transistor, the first terminal refers to a collector or an emitter of the bipolar transistor, and the second terminal refers to an emitter or a collector; or in a case where the transistor is a field-effect transistor, the control terminal of the transistor refers to a gate of the field-effect transistor, the first terminal of the transistor refers to a drain or a source of the field-effect transistor, and the second terminal of the transistor is a source or drain of the field-effect switching transistor.

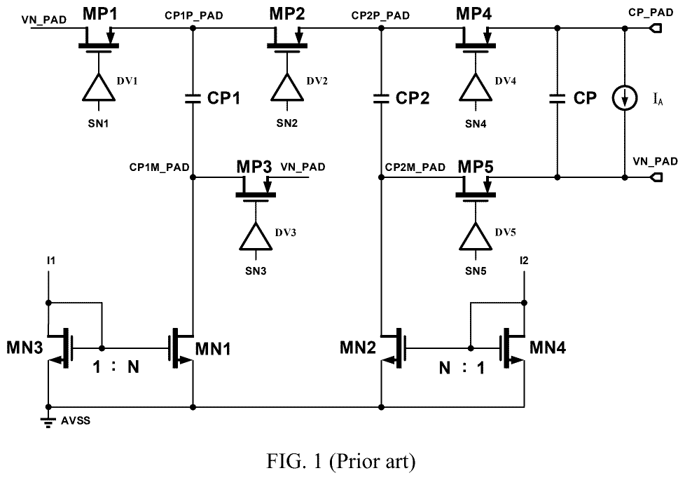

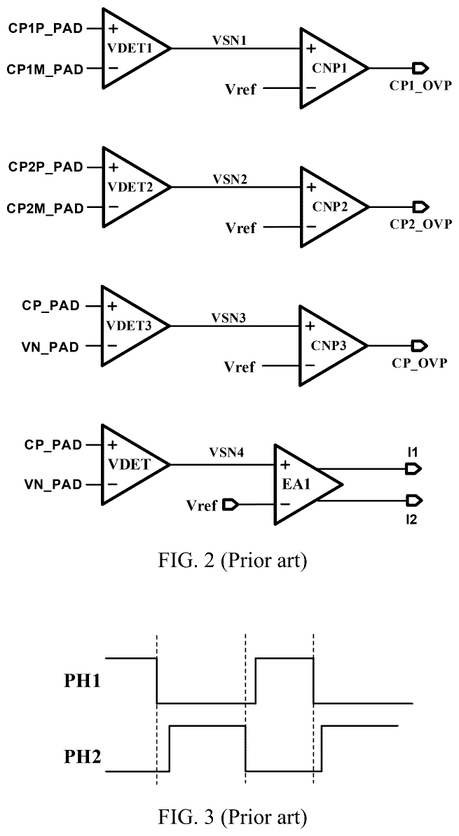

FIG. 1 is a schematic structural diagram of a voltage conversion circuit in the related art. FIG. 2 is a schematic structural diagram of a voltage sampling circuit in the related art. FIG. 3 is a schematic diagram of a clock signal waveform in the related art. Referring to FIG. 1 and FIG. 2, the voltage conversion circuit in the related art mainly includes a capacitor CP1, a capacitor CP2, a capacitor CP, transistors MP1 to MP5, transistors MN1 to MN4, drive circuits DV1 to DV5, voltage sampling modules VDET and VDET1 to VDET3, an error amplifier EA1, comparators CNP1 to CNP3, and a load I_{A}. VN_PAD represents a power access terminal, VN_PAD is electrically connected to a power supply. In FIG. 1, CP1P_PAD, CPIM_PAD, CP2P_PAD, CP2M_PAD, CP_PAD, and VN_PAD all represent voltage sampling points, and input terminals of the voltage sampling modules VDET and VDET1 to VDET3 are electrically connected to corresponding voltage sampling points to acquire voltages across the corresponding capacitors. SN1 to SN5 represent control signals, and are used to control the drive circuits DV1 to DV5 to drive the transistors MP1 to MP5 to be turned on or turned off.

During operation of the voltage conversion circuit in the related art, under dual-phase non-overlapping clock signals PH1 and PH2 as illustrated in FIG. 3, in a case where the clock signal PH1 is at a high level, the transistors MP1, MP4, and MP5 are controlled to be turned on, the transistors MP2 and MP3 are controlled to be turned off, a power access terminal VN_PAD charges the capacitor CP1, and the capacitor CP2 charges the capacitor CP; and in a case where the clock signal PH2 is at a high level, the transistors MP1, MP4, and MP5 are controlled to be turned off, the transistors MP2 and MP3 are controlled to be turned on, the capacitor CP1 charges the capacitor CP2, and the capacitor CP supplies power to the load I_{A}. The voltage sampling module VDET samples a voltage across the capacitor CP, a difference between a sampled voltage signal VSN4 with a reference voltage Vref via the error amplifier EA1 is amplified, and charge currents I1 and I2 are output.

In the related art, amplification factors of the transistors MN3 and the transistor MN4 are both set to N. The charge currents I1 and I2, subsequent to amplification by N times, respectively supply desired charge currents to the capacitor CP1 and the capacitor CP2, such that a voltage across the capacitor CP is maintained at a target value.

The voltage sampling modules VDET1 to VDET3 are configured to respectively sample voltages across the capacitors CP1, CP2, and CP. Sampled voltage signals VSNI to VSN3 are then compared with the reference voltage Vref by comparators CMP1 to CMP3 respectively, to output control signals CP1_OVP, CP2_OVP, and CP_OVP for controlling their respective capacitors. This specifically includes the following operations:

In a case where the voltage across the capacitor CP1 is excessively high, for example, the voltage exceeds a predetermined threshold, the control signal CP1_OVP transitions from a low level to a high level, such that the transistor MN1 is turned off, whereupon the capacitor CP1 ceases to be charged. The voltage across the capacitor CP1 progressively decreases to drop to the predetermined threshold. Subsequently, the control signal CP1_OVP transitions from a high level back to a low level, such that the transistor MN1 is turned on again to charge the capacitor CP1.

In a case where the voltage across the capacitor CP2 is excessively high, the control signal CP2_OVP transitions from a low level to a high level, such that the transistor MN2 is turned off, whereupon the capacitor CP2 ceases to be charged, and the voltage across the capacitor CP2 decreases to drops to the predetermined threshold, such that the transistor MN2 is turned on again to charge the capacitor CP2.

In a case where the voltage across the capacitor CP is excessively high, the control signal CP_OVP transitions from a low level to a high level, such that the transistors MP1 to MP5 and the transistors NM1 to NM4 are all turned off, whereupon the capacitors CP1, CP2, and CP all cease to be charged. This state persists until the voltage across capacitor CP drops to the predetermined threshold, such that the voltage conversion circuit is restarted to charge capacitor CP.

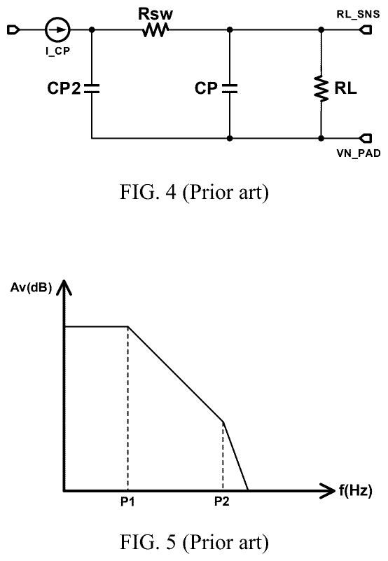

FIG. 4 is a schematic diagram illustrating an equivalent linear model structure of a voltage conversion circuit in the related art. Referring to FIG. 4, in the voltage conversion circuit in the related art, the capacitor CP1 is not within the overall circuit loop and only provides a charge current I_CP to an output stage. The transistors (or switches) MP4 and MP5 may be considered equivalent to a resistor Rsw, and the load I_{A} may be considered equivalent to a resistor RL. RL_SNS and VN_PAD represent voltage sampling points across the resistor RL. Typically, it holds that a capacitor value of the CP is greater than that of the CP2, i.e., CP>CP2, and a resistance value of the RL is greater than that of the Rsw, i.e., RL>Rsw.

FIG. 5 is a Bode plot of an equivalent linear model for an output stage of a voltage conversion circuit in the related art. Referring to FIG. 5, the voltage conversion circuit illustrated in FIG. 1 may be initially approximated as a two-pole system, wherein P1 and P2 represent two poles in the circuit. These two poles may be respectively expressed as:

$$p 1 \approx \frac{1}{2 π ( cp + cp 2 ) \times RL} \qquad Formula ( 1 )$$

$$p 2 \approx \frac{1}{2 π \times cp 2 \times Rsw} \qquad Formula ( 2 )$$

Under a specific operating condition, in a case where the resistance value of the equivalent resistance Rsw is relatively large, a frequency of the pole P2 is liable to be less than a gain bandwidth (GBW) of the voltage conversion circuit, leading to degraded stability of the voltage conversion circuit. Furthermore, in the related art, an error amplifier EA1 exhibits a high low-frequency gain and possesses a low-frequency pole PEA. Consequently, a voltage conversion circuit for a charge pump employing such an error amplifier is substantially a three-pole system. Due to the inherent difficulty in compensating three-pole systems, the stability of such voltage conversion circuits in the related art is compromised.

To overcome the deficiencies in the related art, the present disclosure provides a voltage conversion circuit wherein a compensation resistor is introduced. The compensation resistor, in turn, introduces a zero into the overall voltage conversion circuit, such that the voltage conversion circuit may be substantially equivalent to a single-pole system. This ensures the overall stability of the voltage conversion circuit.

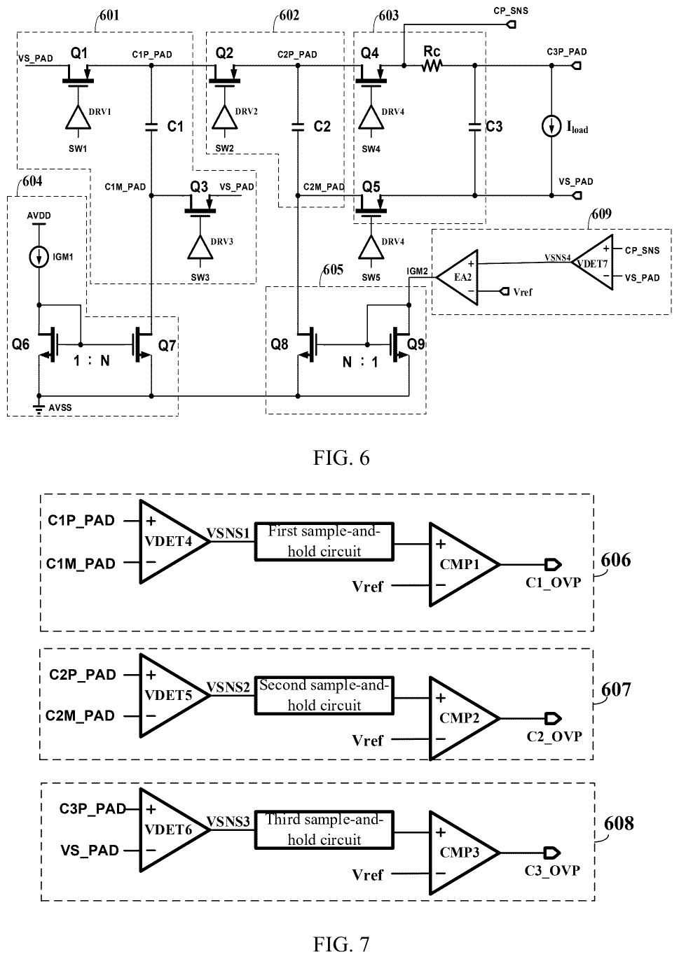

FIG. 6 is a schematic structural diagram of a voltage conversion circuit according to some embodiments of the present disclosure. Referring to FIG. 6, the voltage conversion circuit includes a first charge-discharge branch 601, a second charge-discharge branch 602, a third charge-discharge branch 603, a compensation resistor Rc, a first current branch 604, and a second current branch 605.

The first charge-discharge branch 601, the second charge-discharge branch 602, and the third charge-discharge branch 603 are sequentially connected in parallel, and the compensation resistor Rc is electrically connected in series in the third charge-discharge branch 603. An input terminal of the first charge-discharge branch 601 is electrically connected to a power supply, and an output terminal of the third charge-discharge branch 603 is electrically connected to a load I_{load}. The first current branch 604 and the second current branch 605 are respectively connected in series in the first charge-discharge branch 601 and the second charge-discharge branch 602, and configured to supply charge currents to the first charge-discharge branch 601 and the second charge-discharge branch 602 respectively. At least one transistor is arranged in each of the first charge-discharge branch 601, the second charge-discharge branch 602, the third charge-discharge branch 603, the first current branch 604, and the second current branch 605, wherein a control terminal of the transistor is configured to receive a control signal to control a corresponding branch to be turned on or turned off.

During operation, the voltage conversion circuit utilizes dual-phase non-overlapping clock signals to respectively control the corresponding branches to be turned on or turned off. This enables each charge-discharge branch to are switched between a charge state and a discharge state, such that the supply voltage is boosted or bucked to supply power to the load I_{load}.

In the voltage conversion circuit according to the embodiments of the present disclosure, the compensation resistor introduces a zero into the overall voltage conversion circuit, such that the voltage conversion circuit includes two poles and one zero, and the voltage conversion circuit is substantially equivalent to a single-pole system. Since the single-pole system is readily controlled and compensated, the voltage conversion circuit according to the present disclosure exhibits high overall stability.

In some embodiments, referring to FIG. 6, the first charge-discharge branch 601 includes a first capacitor C1, the second charge-discharge branch 602 includes a second capacitor C2, and the third charge-discharge branch 603 includes a third capacitor C3. The alternating charge-discharge of the first capacitor C1, the second capacitor C2, and the third capacitor C3 implements the operating process of the voltage conversion circuit.

FIG. 7 is a schematic structural diagram of a voltage sampling circuit arrangement according to some embodiments of the present disclosure. Referring to FIG. 7, the voltage conversion circuit further includes a first voltage sampling circuit 606, a second voltage sampling circuit 607, and a third voltage sampling circuit 608.

The first voltage sampling circuit 606 is configured to sample a first voltage across the first capacitor C1, and perform logic processing on the first voltage to output a first control signal. The first control signal is used to control the first current branch 601 to be turned on or turned off. The second voltage sampling circuit 607 is configured to sample a second voltage across the second capacitor C2, and perform logic processing on the second voltage to output a second control signal. The second control signal is used to control the second current branch 602 to be turned on or turned off. The third voltage sampling circuit 608 is configured to sample a third voltage across the third capacitor C3, and perform logic processing on the third voltage to output a third control signal. The third control signal is used to control the first charge-discharge branch 601, the second charge-discharge branch 602, the third charge-discharge branch 603, the first current branch 604, and the second current branch 605 to be simultaneously turned on or turned off.

In some embodiments, each of the first voltage sampling circuit 606, the second voltage sampling circuit 607, and the third voltage sampling circuit 608 includes a voltage acquisition module, a sample-and-hold circuit, and a comparator. An input terminal of the voltage acquisition module serves as a voltage sampling terminal. An output terminal of the voltage acquisition module is electrically connected to an input terminal of the sample-and-hold circuit. An output terminal of the sample-and-hold circuit is electrically connected to a non-inverting input terminal of the comparator, and an inverting input terminal of the comparator is configured to receive a reference voltage signal. The voltage acquisition module is configured to sample a corresponding voltage signal. The sample-and-hold circuit is configured to hold a state of the sampled voltage signal. The comparator is configured to perform logic processing on the sampled voltage signal and the reference voltage signal to output a corresponding control signal.

Specifically, referring to FIG. 7, the first voltage sampling circuit 606 includes a first voltage acquisition module VDET4, a first sample-and-hold circuit, and a first comparator CMP1. The first voltage acquisition module VDET4 is configured to sample a first voltage signal VSNS1 across the first capacitor C1. The first sample-and-hold circuit is configured to hold a state of the sampled first voltage signal VSNS1. The first comparator CMP1 is configured to perform logic processing on the sampled first voltage signal VSNS1 and a reference voltage signal Vref to output a corresponding control signal C1_OVP. The control signal C1_OVP is used to control a sixth transistor Q6 in the first current branch 604 to be turned on or turned off, such that the first current branch 604 is controlled to be turned on or turned off.

The second voltage sampling circuit 607 includes a second voltage acquisition module VDET5, a second sample-and-hold circuit, and a second comparator CMP2. The second voltage acquisition module VDET5 is configured to sample a second voltage signal VSNS2 across the second capacitor C2. The second sample-and-hold circuit is configured to hold a state of the sampled second voltage signal VSNS2. The second comparator CMP2 is configured to perform logic processing on the sampled second voltage signal VSNS2 and the reference voltage signal Vref to output a corresponding control signal C2_OVP. The control signal C2_OVP is used to control an eighth transistor Q8 in the second current branch 605 to be turned on or turned off, such that the second current branch 605 is controlled to be turned on or turned off.

The third voltage sampling circuit 608 includes a third voltage acquisition module VDET6, a third sample-and-hold circuit, and a third comparator CMP3. The third voltage acquisition module VDET6 is configured to sample a third voltage signal VSNS3 across the third capacitor C3. The third sample-and-hold circuit is configured to hold a state of the sampled third voltage signal VSNS3. The third comparator CMP3 is configured to perform logic processing on the sampled third voltage signal VSNS3 and the reference voltage signal Vref to output a corresponding control signal C3_OVP. The control signal C3_OVP is used to control the first current branch 604 and the second current branch 605 to be simultaneously turned on or turned off.

Specifically, referring to FIG. 7, CIP_PAD, CIM_PAD, C2P_PAD, C2M_PAD, C3P_PAD, VS_PAD, and CP_SNS are all voltage sampling points. Input terminals of the respective voltage acquisition modules are electrically connected to the corresponding voltage sampling points to sample the respective voltage signals.

It is apparent that, in the voltage sampling circuit according to the embodiments of the present disclosure, configuration of the sample-and-hold circuit ensures the sampling precision of the voltage across each of the storage capacitors. Controlling the circuit based on accurately sampled voltages ensures that the circuit operates in a correct operating state.

An output terminal of the first voltage sampling circuit 606 is electrically connected to a control terminal of a seventh transistor Q7 to control the seventh transistor Q7 to be turned on or turned off. An output terminal of the second voltage sampling circuit 607 is electrically connected to a control terminal of the eighth transistor Q8 to control the eighth transistor Q8 to be turned on or turned off, and an output terminal of the third voltage sampling circuit 608 is electrically connected to the control terminals of both the seventh transistor Q7 and the eighth transistor Q8 to control the seventh transistor Q7 and the eighth transistor Q8 to be simultaneously turned on or turned off.

In the embodiments of the present disclosure, to eliminate the impacts of the ripples and operating points of the capacitors on the sampling precision of the voltage acquisition modules VDET4 to VDET6, and to prevent erroneous state transitions of the comparators CMP1 to CMP3, three sample-and-hold (S/H) circuits are respectively added between the first voltage acquisition module VDET4 and the non-inverting input terminal of the first comparator CMP1, between the second voltage acquisition module VDET5 and the non-inverting input terminal of the second comparator CMP2, and between the third voltage acquisition module VDET6 and the non-inverting input terminal of the third comparator CMP3. For the first comparator CMP1, in a case where a clock signal PH2 is at a high level, the first comparator CMP1 is in a “sample” state; and in a case where a clock signal PH1 is at a high level, the first comparator CMP1 is in a “hold” state. For the second comparator CMP2, in a case where the clock signal PH1 is at a high level, the second comparator CMP2 is in a “sample” state; and in a case where the clock signal PH2 is at a high level, the second comparator CMP2 is in a “hold” state. For the third comparator CMP3, in a case where the clock signal PH2 is at a high level, the third comparator CMP3 is in a “sample” state; and in a case where the clock signal PH1 is at a high level, the third comparator CMP3 is in a “hold” state.

In some embodiments, the voltage conversion circuit further includes a fourth voltage sampling circuit 609. The compensation resistor Rc and the third capacitor C3 are connected in series, a sampling terminal of the fourth voltage sampling circuit 609 is configured to acquire a fourth voltage VSNS4 across a series connection of the compensation resistor Rc and the third capacitor C3 and output a second charge current subsequent to performing logic processing on the fourth voltage VSNS4, and an output terminal of the fourth voltage sampling circuit 609 is electrically connected to an input terminal of the second current branch 602 and configured to input the second charge current to the second current branch 602. The second charge current is used to charge the second capacitor C2. In the embodiments of the present disclosure, in a case where the fourth voltage sampling circuit 609 is employed to sample the voltage across the third capacitor C3, the introduction of the compensation resistor Rc reduces the voltage conversion circuit to a single-pole loop. This enables more precise regulation and control of an output second charge current, such that the charge precision for the third capacitor C3 is ensured.

Specifically, in the embodiments of the present disclosure, the first charge-discharge branch 601 further includes a first transistor Q1 and a third transistor Q3, the second charge-discharge branch 602 further includes a second transistor Q2, and the third charge-discharge branch 603 further includes a fourth transistor Q4 and a fifth transistor Q5. A first terminal of the first transistor Q1 is electrically connected to a power supply. Specifically, the first terminal of the first transistor Q1 may be electrically connected to a power supply pin VS_PAD of the power supply. A second terminal of the first transistor Q1 is electrically connected to a first terminal of the first capacitor C1. A second terminal of the first capacitor C1 is electrically connected to an output terminal of the first current branch 604. A first terminal of the third transistor Q3 is electrically connected to the second terminal of the first capacitor C1. A second terminal of the third transistor Q3 is electrically configured to be connected to the power supply pin VS_PAD of the power supply. A first terminal of the second transistor Q2 is electrically connected to the first terminal of the first capacitor C1, a second terminal of the second transistor Q2 is electrically connected to a first terminal of the second capacitor C2, and a second terminal of the second capacitor C2 is electrically connected to an output terminal of the second current branch 605. A first terminal of the fourth transistor Q4 is electrically connected to the first terminal of the second capacitor C2, a second terminal of the fourth transistor Q4 is electrically connected to a first terminal of the third capacitor C3 via the compensation resistor Rc, a first terminal of the fifth transistor Q5 is electrically connected to the second terminal of the second capacitor C2, a second terminal of the fifth transistor Q5 is electrically connected to a second terminal of the third capacitor C3, and two terminals of the third capacitor C3 are electrically connected to the load I_{load} to supply power to the load I_{load}.

Control terminals of the first transistor Q1, the second transistor Q2, the third transistor Q3, the fourth transistor Q4, and the fifth transistor Q5 are configured to receive their respective control signals. The control signals are respectively used to control the first transistor Q1, the second transistor Q2, the third transistor Q3, the fourth transistor Q4, and the fifth transistor Q5 to be turned on or turned off.

In some embodiments, the first transistor Q1, the second transistor Q2, the third transistor Q3, the fourth transistor Q4, and the fifth transistor Q5 in FIG. 6 are all P-channel metal-oxide-semiconductor field-effect transistors (PMOSFETs), wherein first terminals of the transistors are drains, second terminals of the transistors are sources, and control terminals of the transistors are gates.

In some embodiments, the first current branch 604 includes a first current source IGM1, a sixth transistor Q6, and a seventh transistor Q7. An input terminal of the first current source IGM1 is configured to receive an analog voltage AVDD, and an output terminal of the first current source IGM1 is electrically connected to a first terminal of the sixth transistor Q6, a control terminal of the sixth transistor Q6 is electrically connected to a control terminal of the seventh transistor Q7, a first terminal of the seventh transistor Q7 serves as an output terminal of the first branch circuit 604 and is electrically connected to the second terminal of the first capacitor C1, the first terminal of the sixth transistor Q6 is further electrically connected to the control terminal of the seventh transistor Q7, and both second terminals of the sixth transistor Q6 and a second terminal of the seventh transistor Q7 are grounded. Specifically, an output terminal of the first voltage sampling circuit 606 is electrically connected to a control terminal of a seventh transistor Q7 to control the seventh transistor Q7 to be turned on or turned off.

It is apparent that, in the embodiments, the charge current for the first capacitor C1 is supplied by a first current source IGM1 and is no longer controlled by the error amplifier EA1. The first charge current supplied by the first current source IGM1 in the embodiments is greater than the second charge current output by the fourth voltage sampling circuit 609. This is to ensure that the charge current of C1 is always greater than its discharge current. Otherwise, during a period when PH2 is at a high level, the second capacitor C2 may reversely charge the first capacitor C1, leading to a reduction in charge pump efficiency, and potentially even preventing the voltage across the third capacitor C3 from reaching a target value.

In some embodiments, the second current branch 605 includes an eighth transistor Q8 and a ninth transistor Q9. A first terminal of the ninth transistor Q9 serves as the input terminal of the second current branch 605 and is configured to receive a second charge current IGM21 output from the fourth voltage sampling circuit 609, a control terminal of the ninth transistor Q9 is electrically connected to a control terminal of the eighth transistor Q8, a first terminal of the eighth transistor Q8 serves as an output terminal of the second current branch 605 and is electrically connected to a second terminal of the second capacitor C2, a first terminal of the ninth transistor Q9 is electrically connected to the control terminal of the eighth transistor Q8, and both second terminals of the eighth transistor Q8 and a second terminal of the ninth transistor Q9 are grounded.

An amplification factor for a current mirror arrangement involving a sixth transistor Q6 may be set to N, and an amplification factor for a current mirror arrangement involving a ninth transistor Q9 may also be set to N. The first current source IGM1, subsequent to amplification by N times, charges the first capacitor C1. The second charge current IGM21 output by the fourth voltage sampling circuit, subsequent to amplification by N times, charges the second capacitor C2.

In some embodiments, the sixth transistor Q6, the seventh transistor Q7, and the eighth transistor Q8, and the ninth transistor Q9 in FIG. 6 are all N-channel metal-oxide-semiconductor field-effect transistors (NMOSFETs), wherein first terminals of the transistors are drains, second terminals of the transistors are sources, and control terminals of the transistors are gates.

In some embodiments, the fourth voltage sampling circuit 609 includes a fourth voltage acquisition module VDET7 and an error amplifier EA2. An input terminal of the voltage acquisition module VDET7 serves as the sampling terminal of the fourth voltage sampling circuit 609, and an output terminal of the voltage acquisition module VDET7 is electrically connected to a non-inverting input terminal of the error amplifier EA2, an inverting input terminal of the error amplifier EA2 is configured to receive the reference voltage signal Vref, an output terminal of the error amplifier EA2 serves as an output terminal of the fourth voltage sampling circuit 609 and is electrically connected to the first terminal of the ninth transistor Q9.

The fourth voltage acquisition module VDET7 is configured to acquire a fourth voltage across a series connection of the compensation resistor Rc and the third capacitor C3, and the error amplifier EA2 is configured to amplify an error between the fourth voltage and the reference voltage signal Vref and output the second charge current to the second current branch 605.

In some embodiments, in a case where a fourth voltage sampling circuit 609 is employed to sample the voltage across the third capacitor C3, the introduction of a compensation resistor Rc reduces the voltage conversion circuit to a single-pole loop. This enables more precise regulation and control of the output second charge current, and the introduction of an error amplifier EA2 ensures the sampling precision of the fourth voltage, such that the charge precision for the third capacitor C3 is ensured.

In some embodiments, the voltage conversion circuit further includes a first drive circuit DRV1, a second drive circuit DRV2, a third drive circuit DRV3, a fourth drive circuit DRV4, and a fifth drive circuit DRV5. An output terminal of the first drive circuit DRV1 is electrically connected to the control terminal of the first transistor Q1, an output terminal of the second drive circuit DRV2 is electrically connected to the control terminal of the second transistor Q2, an output terminal of the third drive circuit DRV3 is electrically connected to the control terminal of the third transistor Q3, an output terminal of the fourth drive circuit DRV4 is electrically connected to the control terminal of the fourth transistor Q4, and an output terminal of the fifth drive circuit DRV5 is electrically connected to the control terminal of the fifth transistor Q5.

Input terminals of the first drive circuit DRV1, the second drive circuit DRV2, the third drive circuit DRV3, the fourth drive circuit DRV4, and the fifth drive circuit DRV5 are configured to receive the control signals SW1 to SW5 respectively. The first drive circuit DRV1, the second drive circuit DRV2, the third drive circuit DRV3, the fourth drive circuit DRV4, and the fifth drive circuit DRV5 are configured to generate respective switch drive signals based on the control signals SW1 to SW5 respectively. The switch drive signals are respectively used to control the first transistor Q1, the second transistor Q2, the third transistor Q3, the fourth transistor Q4, and the fifth transistor Q5 to be turned on or turned off.

The error amplifier EA1 in the related art possesses a low-frequency pole PEA, which adds poles to the voltage conversion circuit, such that it is difficult to compensate the voltage conversion circuit. To overcome this technical problem, some embodiments of the present disclosure further provide an error amplifier EA2 that has an open-loop current limiting structure and is free of low-frequency poles.

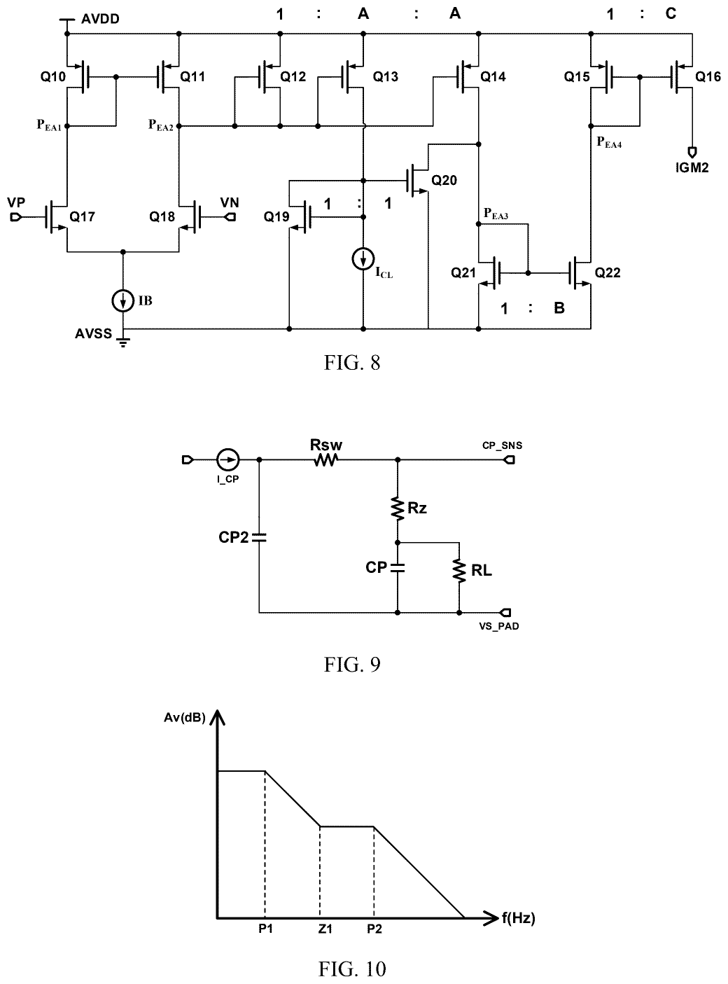

FIG. 8 is a schematic structural diagram illustrating a circuit structure of an error amplifier according to some embodiments of the present disclosure. Referring to FIG. 8, the error amplifier includes a tenth transistor Q10, an eleventh transistor Q11, a twelfth transistor Q12, a thirteenth transistor Q13, a fourteenth transistor Q14, a fifteenth transistor Q15, a sixteenth transistor Q16, a seventeenth transistor Q17, an eighteenth transistor Q18, a nineteenth transistor Q19, a twentieth transistor Q20, a twenty-first transistor Q21, a twenty-second transistor Q22, a second current source IB, and a third current source I_{cl}.

A first terminal of the tenth transistor Q10 is configured to receive an analog voltage AVDD, a second terminal of the tenth transistor Q10 is electrically connected to a first terminal of the seventeenth transistor Q17, a second terminal of the seventeenth transistor Q17 is electrically connected to an input terminal of a second current source IB, and an output terminal of the second current source IB is grounded; a first terminal of the eleventh transistor Q11 is further configured to receive the analog voltage AVDD, a second terminal of the eleventh transistor Q11 is electrically connected to a first terminal of the eighteenth transistor Q18, and a second terminal of the eighteenth transistor Q18 is electrically connected to the input terminal of the second current source IB; a control terminal of the tenth transistor Q10 and a control terminal of the eleventh transistor Q11 are electrically connected; a control terminal of the seventeenth transistor Q17 is electrically connected to an output terminal of the sample-and-hold circuit in the fourth voltage sampling circuit 609, and a control terminal of the eighteenth transistor Q18 is configured to receive a reference voltage signal; a first terminal of the twelfth transistor Q12 is configured to receive the analog voltage AVDD, and a second terminal and a control terminal of the twelfth transistor Q12 are both electrically connected to the second terminal of the eleventh transistor Q11; a first terminal of the thirteenth transistor Q13 is configured to receive the analog voltage AVDD, a second terminal of the thirteenth transistor Q13 is electrically connected to an input terminal of the third current source I_{cl}, an output terminal of the third current source I_{cl} is grounded, and a control terminal of the thirteenth transistor Q13 is electrically connected to the second terminal of the eleventh transistor Q11; a first terminal and a control terminal of a nineteenth transistor Q19 are both electrically connected to the second terminal of the thirteenth transistor Q13, and a second terminal of the nineteenth transistor Q19 is grounded; a first terminal of the fourteenth transistor Q14 is electrically configured to receive the analog voltage AVDD, a second terminal of the fourteenth transistor Q14 is electrically connected to a first terminal of the twentieth transistor Q20, and a control terminal of the fourteenth transistor Q14 is electrically connected to the second terminal of the eleventh transistor Q11; a second terminal of the twentieth transistor Q20 is grounded, and a control terminal of the twentieth transistor Q20 is electrically connected to the second terminal of the thirteenth transistor Q13; a first terminal of the twenty-first transistor Q21 is electrically connected to the second terminal of the fourteenth transistor Q14, a second terminal of the twenty-first transistor Q21 is grounded, a control terminal of the twenty-first transistor Q21 is electrically connected to a control terminal of a twenty-second transistor Q22, the control terminal of the twenty-first transistor Q21 is further electrically connected to the first terminal of the twentieth transistor Q20 thereof; a first terminal of the fifteenth transistor Q15 is configured to receive the analog voltage AVDD, a second terminal of the fifteenth transistor Q15 is electrically connected to a first terminal of the twenty-second transistor Q22, a control terminal of the fifteenth transistor Q15 is electrically connected to a control terminal of a sixteenth transistor Q16, and the control terminal of the fifteenth transistor Q15 is further electrically connected to its own second terminal; and a second terminal of the twenty-second transistor Q22 is grounded to an analog ground AVSS, a first terminal of the sixteenth transistor Q16 is configured to receive the analog voltage AVDD, and a second terminal of the sixteenth transistor Q16 is configured to output the second charge current.

In some embodiments, the tenth transistor Q10, the eleventh transistor Q11, the twelfth transistor Q12, the thirteenth transistor Q13, the fourteenth transistor Q14, the fifteenth transistor Q15, and the sixteenth transistor Q16 in FIG. 8 are all PMOSFETs, wherein first terminals of the transistors are sources, second terminals of the transistors are drains, and control terminals of the transistors are gates.

In some embodiments, the seventeenth transistor Q17, the eighteenth transistor Q18, the nineteenth transistor Q19, the twentieth transistor Q20, the twenty-first transistor Q21, and the twenty-second transistor Q22 in FIG. 8 are all NMOSFETs, wherein first terminals of the transistors are drains, second terminals of the transistors are sources, and control terminals of the transistors are gates.

The transistors Q17 to Q22 and Q10 to Q16 form an error amplifier EA2 that is free of low-frequency poles. Each stage of the error amplifier EA2 utilizes a current mirror structure. Each of poles PEA1 to PEA4 within the error amplifier EA2 may be pushed to a high frequency by increasing branch currents, thereby obviating the need for loop compensation. In a case where an amplification factor of the transistor Q13 is A, an amplification factor of the transistor Q16 is C, and an amplification factor of the transistor Q21 is B, then a current signal between the transistor Q12 and the transistor Q14 is amplified by a ratio of 1:A, a current signal between the transistor Q21 and the transistor Q22 is amplified by a ratio of 1:B, and a current signal between the transistor Q15 and the transistor Q16 is amplified by a ratio of 1:C. In a case where transconductances of the transistor Q17 and the transistor Q18 are both gm, then an equivalent transconductance of the error amplifier EA2 is Gm=gm×A×B×C. The transistors Q13, Q19, Q20, and a current source I_{CL} form an open-loop current limiting circuit. When a current limit point is triggered, the second charge current output by EA2 is IGM21=I_{CL}×B×C.

The charge pump loop according to the embodiments of the present disclosure provides feedback control for the charge current of the second capacitor C2 by sampling the voltage across the compensation resistor Rc and the third capacitor C3 (i.e., across a series connection of the compensation resistor Rc and the third capacitor C3). Due to the introduction of the compensation resistor Rc, significant ripples may appear at the sampling point CP_SNS. The voltage signal VSNS output by VDET may also exhibit significant ripples, which may trigger the current limiting circuit within the error amplifier (i.e., EA2 herein). Therefore, a sample-and-hold circuit is added between VSNS and the non-inverting input terminal of the error amplifier. In a case where a clock signal PH1 is at a high level, the voltage conversion circuit is operating, and the error amplifier EA2 is in a “sample” state. In a case where a clock signal PH2 is at a high level, the voltage conversion circuit is not operating, and the error amplifier EA2 is in a “hold” state.

FIG. 9 is a schematic diagram of an equivalent linear model for an output stage of a voltage conversion circuit according to some embodiments of the present disclosure. Referring to FIG. 9, under typical conditions, a capacitor value of the C3 is greater than that of the C2, i.e., C3>C2, and a resistance value of the RL is greater than that of the Rz, and the resistance value of the Rz is greater than that of the Rsw, i.e., RL>Rz>Rsw. FIG. 10 is a Bode plot of an equivalent linear model according to some embodiments of the present disclosure. Referring to FIG. 10, the voltage conversion circuit according to the embodiments includes two poles (P1 and P2) and one zero (Z1), and may therefore be approximated as a single-pole system. The poles and the zero may be respectively expressed as:

$$p 1 \approx \frac{1}{2 π ( c 3 + c 2 ) \times RL} \qquad Formula ( 3 )$$

$$p 2 \approx \frac{1}{2 π \times c 2 \times ( Rz + Rsw )} \qquad Formula ( 4 )$$

$$Z 1 \approx \frac{1}{2 π \times c 3 \times ( Rz + Rsw )} \qquad Formula ( 5 )$$

It is apparent that, in the embodiments, the gain of the error amplifier EA2 is relatively low, no high-frequency poles are present, and the poles of the error amplifier EA2 are both pushed to frequencies significantly greater than the GBW of the circuit. This ensures that the voltage conversion circuit has a phase margin close to 90 degrees, exhibiting excellent stability. Consequently, a charge pump employing the voltage conversion circuit also exhibits excellent stability.

Some embodiments further provide a charge pump. The charge pump includes the voltage conversion circuit as described above. The operating process and functional effects of the charge pump according to the embodiments may be understood by reference to the voltage conversion circuit, which are not described herein any further.

In some embodiments, the charge pump further includes a logic control circuit. The logic control circuit includes a plurality of enable terminals. The plurality of enable terminals are respectively electrically connected to the input terminals of the first drive circuit DRV1, the second drive circuit DRV2, the third drive circuit DRV3, the fourth drive circuit DRV4, and the fifth drive circuit DRV5 in the voltage conversion circuit. The logic control circuit is configured to, under dual-phase non-overlapping clock signals, output their respective control signals to control corresponding drive circuits to generate their respective switch drive signals. The switch drive signals are configured to control the respective transistors to be turned on or turned off respectively, thereby implementing the functionality of the charge pump.

It is to be understood that, in some embodiments, in addition to the voltage conversion circuit and the logic control circuit, the charge pump may further include related peripheral circuits to implement the functionality of the charge pump, which are not described herein any further. Some embodiments of the present disclosure further provide a chip. The chip includes the voltage conversion circuit as described above or the charge pump as described above. In other words, the voltage conversion circuit, the charge pump, or the related peripheral circuits are integrated into a single chip to facilitate direct use in electronic devices and improve the production efficiency of electronic devices. The operating process and functional effects of the chip according to the embodiments may be understood by reference to the voltage conversion circuit, which are not described herein any further.

Some embodiments further provide an electronic device. The electronic device includes the chip as described above.

It is to be understood that, in some other embodiments, in addition to the chip, the electronic device may further include related hardware such as a housing, a circuit board, a power supply, and communication interfaces, which are not described herein any further.

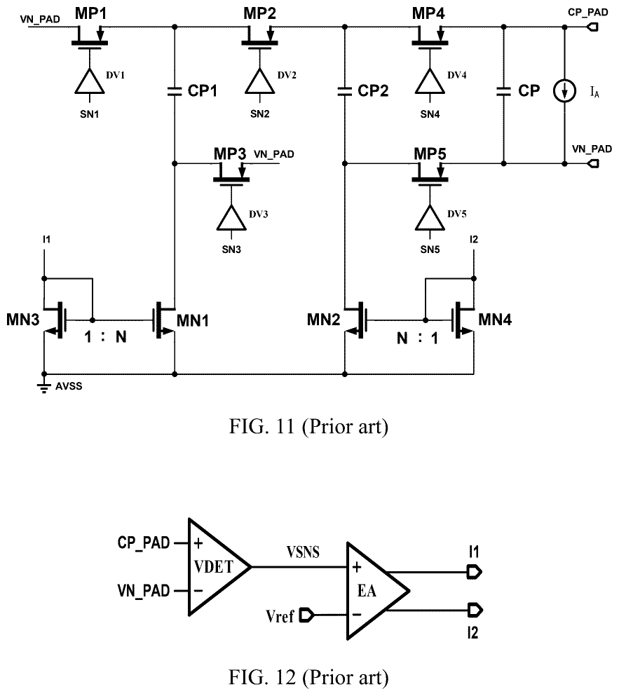

FIG. 11 is a schematic structural diagram of a voltage conversion circuit in the related art. Referring to FIG. 11, the voltage conversion circuit primarily includes: the capacitors CP1, CP2, and CP; the drive circuits DV1 to DV5; the transistors MP1 to MP5; and the transistors MN1 to MN4. The capacitors CP1, CP2, and CP are configured to store energy. By controlling the transistors MP1 to MP5 and the transistors MN1 to MN4, the capacitors CP1, CP2, and CP are switched between charge-discharge to output a stable supply voltage to the load I_{A}. In FIG. 11, VN_PAD represents a power supply access terminal, and VN_PAD is configured to be connected to a power supply. CP_PAD and VN_PAD represent voltage sampling points across the capacitor CP. SN1 to SN5 are control signals, and the control signals SN1 to SN5 are respectively used to control the drive circuits DV1 to DV5 to drive the transistors MP1 to MP5 to be turned on or turned off.

FIG. 12 is a schematic structural diagram of a charge control circuit in the related art. Referring to FIG. 12, the charge control circuit includes a voltage acquisition module VDET and an error amplifier (EA). VN_PAD represents a power access terminal, and VN_PAD is configured to be connected to a power supply. The voltage acquisition module VDET is configured to sample a voltage signal VSNS across the capacitor CP. The error amplifier EA, based on a comparison between the voltage signal VSNS and the reference voltage Vref, outputs a charge current I1 and a charge current I2. The charge current I1 is used to charge the capacitor CP1, and the charge current I2 is used to charge the capacitor CP2.

During operation of the voltage conversion circuit in the related art, under dual-phase non-overlapping clock signals PH1 and PH2 as illustrated in FIG. 3, in a case where the clock signal PH1 is at a high level, the transistors MP1, MP4, and MP5 are controlled to be turned on, the transistors MP2 and MP3 are controlled to be turned off, a power access terminal VN_PAD charges the capacitor CP1, and the capacitor CP2 charges the capacitor CP; and in a case where the clock signal PH2 is at a high level, the transistors MP1, MP4, and MP5 are controlled to be turned off while the transistors MP2 and MP3 are controlled to be turned on, the capacitor CP1 charges the capacitor CP2, and the capacitor CP supplies power to the load I_{A}. The voltage acquisition module VDET samples a voltage across the capacitor CP, amplifies a difference between a sampled voltage signal VSN with the reference voltage Vref via the error amplifier, and outputs charge currents I1 and I2.

In the related art, an amplification factor between transistor MN3 and transistor MN1 is set to N, and an amplification factor between transistor MN2 and transistor MN4 is also set to N. The charge currents I1 and I2, subsequent to amplification by N times, respectively supply desired charge currents to the capacitor CP1 and the capacitor CP2, such that a voltage across the capacitor CP is maintained at a target value.

Referring to FIG. 4, in the voltage conversion circuit in the related art, the capacitor CP1 is not within the overall circuit loop and only provides a charge current I_CP to an output stage. The transistors (or switches) MP4 and MP5 may be considered equivalent to a resistor Rsw, and the load I_{A} may be considered equivalent to a resistor RL. RL_SNS and VN_PAD represent voltage sampling points across the resistor RL. Typically, it holds that a capacitor value of the CP is greater than that of the CP2, i.e., CP>CP2, and a resistance value of the RL is greater than that of the Rsw, i.e., RL>Rsw.

Referring to FIG. 5, the voltage conversion circuit illustrated in FIG. 1 may be initially approximated as a two-pole system, wherein P1 and P2 represent two poles in the circuit. These two poles may be respectively expressed as:

$$p 1 \approx \frac{1}{2 π ( cp + cp 2 ) \times RL} \qquad Formula ( 1 )$$

$$p 2 \approx \frac{1}{2 π \times cp 2 \times Rsw} \qquad Formula ( 2 )$$

In formulas (1) and (2), P1 and P2 represent two poles in the circuit, RL and Rsw represent equivalent resistors, and CP and CP2 represent capacitors.

Under a specific operating condition, in a case where the resistance value of the equivalent resistance Rsw is relatively large, a frequency of the pole P2 is liable to be less than the GBW of the voltage conversion circuit, leading to degraded stability of the voltage conversion circuit. Furthermore, in the related art, an error amplifier EA exhibits a high low-frequency gain and possesses a low-frequency pole PEA. Consequently, a voltage conversion circuit for a charge pump employing such an error amplifier is substantially a three-pole system. Due to the inherent difficulty in compensating three-pole systems, the stability of such voltage conversion circuits in the related art is compromised.

To overcome the defects in the related art, the present disclosure provides a voltage conversion circuit. The voltage conversion circuit is based on a Bang-Bang control concept. The voltage conversion circuit includes a first charge circuit, a second charge circuit, a first charge control circuit, and a second charge control circuit. The first charge control circuit is configured to sample a first voltage across a first energy store, and generate a first charge control signal based on the first voltage; the second charge control circuit is configured to sample a second voltage across a second energy store, and generate a second charge control signal based on the second voltage; the first charge control signal is used to control the first charge circuit to be turned on or turned off; the second charge control signal is used to control the second charge circuit to be turned on or turned off; the first charge circuit in an on state is configured to output a first charge current to a first energy storage circuit; and the second charge circuit in an on state is configured to output a second charge current to a second energy storage circuit. This enables the first energy store and the second energy store to are switched between a charge state and a discharge state, such that a voltage at an output terminal of the voltage conversion circuit is stabilized at a target value or within a target range.

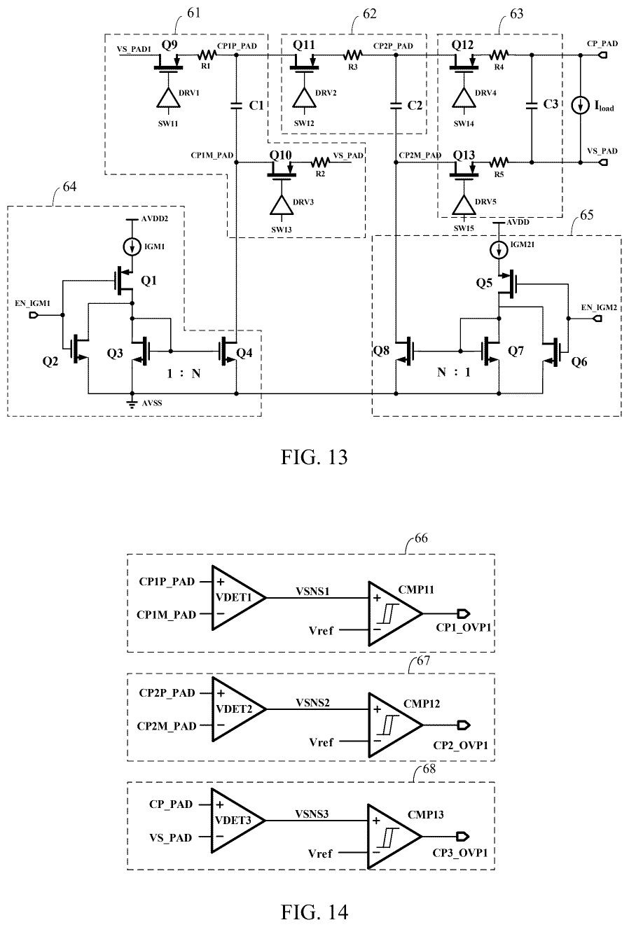

FIG. 13 is a schematic structural diagram of a voltage conversion circuit according to some embodiments of the present disclosure. Referring to FIG. 13, the voltage conversion circuit includes a first energy storage circuit 61, a second energy storage circuit 62, a third energy storage circuit 63, a first charge circuit 64, a second charge circuit 65, a first charge control circuit 66, and a second charge control circuit 67.

The first energy storage circuit 61, the second energy storage circuit 62, and the third energy storage circuit 63 are connected in parallel, a first terminal of the first energy storage circuit 61 is electrically connected to a first power supply VS_PAD1, and two terminals of the third energy storage circuit 63 are electrically connected to the load I_{load}. The first energy storage circuit 61 includes a first energy store, and the second energy storage circuit 62 includes a second energy store. The first energy store and the second energy store are both configured to store energy.

FIG. 14 is a schematic structural diagram of a charge control circuit according to some embodiments of the present disclosure. Referring to FIG. 14, the first charge control circuit 66 is configured to acquire a first voltage across the first energy store and generate a first charge control signal CP1_OVP1 based on the first voltage, and the second charge control circuit 67 is configured to acquire a second voltage across the second energy store and generate a second charge control signal CP2_OVP1 based on the second voltage. The first charge control signal CP1_OVP1 is used to control the first charge circuit 64 to be turned on or turned off, and the second charge control signal CP2_OVP1 is used to control the second charge circuit 65 to be turned on or turned off. The first charge circuit 64 in an on state is configured to output a first charge current to the first energy storage circuit 61, and the second charge circuit 65 in an on state is configured to output a second charge current to the second energy storage circuit 65.

The first energy storage circuit 61, the second energy storage circuit 62, and the third energy storage circuit 63 are configured to receive their respective switch drive signals respectively. The switch drive signals are used to respectively control the first energy storage circuit 61, the second energy storage circuit 62, and the third energy storage circuit 63 to be turned on or turned off, such that the first energy storage circuit 61, the second energy storage circuit 62, and the third energy storage circuit 63 are switched between a charge state and a discharge state respectively.

In the embodiments, the voltages across the first energy store and the second energy store are acquired, and respective charge control signals based on the acquired voltages are generated, to control the first charge circuit 64 and the second charge circuit 65 to be turned on or turned off. In this way, the first energy storage circuit 61, the second energy storage circuit 62, and the third energy storage circuit 63 are controlled to are switched between a charge state and a discharge state, such that the voltage at the output terminal of the voltage conversion circuit is stabilized (maintained) at a target value or within a target value range.

Still referring to FIG. 14, the third energy storage circuit 63 includes a third energy store. The third energy store is also used to store energy. The voltage conversion circuit further includes a third charge control circuit 68. The third charge control circuit 68 is configured to sample a third voltage across the third energy store and generate a third charge control signal CP3_OVP1 based on the third voltage. The third charge control signal CP3_OVP1 is configured to the first charge circuit 64 and the second charge circuit 65 to be simultaneously turned on or turned off.

In some embodiments, the first charge control signal CP1_OVP1 includes a first charge enable signal and a first charge disable signal. The first charge enable signal is used to control the first charge circuit 64 to be turned on, and the first charge disable signal is used to control the first charge circuit 64 to be turned off. The first charge control circuit 66 is specifically configured to: generate the first charge enable signal in a case where the first voltage is less than a first predetermined value, to control the first charge circuit 64 to be turned on to charge the first energy store; and generate the first charge disable signal in a case where the first voltage is greater than a second predetermined value, to control the first charge circuit 64 to be turned off to cease to charge the first energy store.

In some embodiments, the second charge control signal CP2_OVP1 includes a second charge enable signal and a second charge disable signal. The second charge enable signal is used to control the second charge circuit 65 to be turned on, and the second charge disable signal is used to control the second charge circuit 65 to be turned off. The second charge control circuit 67 is specifically configured to: generate the second charge enable signal in a case where the second voltage is less than the first predetermined value, to control the second charge circuit 65 to be turned on to charge the second energy store; and generate the second charge disable signal in a case where the second voltage is greater than the second predetermined value, to control the second charge circuit 65 to be turned off to cease to charge the second energy store.

In some embodiments, the third charge control signal CP3_OVP1 includes a third charge enable signal and a third charge disable signal. The third charge enable signal is used to control the first charge circuit 64 and the second charge circuit 65 to be simultaneously turned on, and the third charge disable signal is used to control the first charge circuit 64 and the second charge circuit 65 to be simultaneously turned off. The third charge control circuit 68 is specifically configured to: generate the third charge enable signal in a case where the third voltage is less than the first predetermined value, to control the first charge circuit 64 and the second charge circuit 65 to be simultaneously turned on to charge the first energy store and the second energy store; and generate the third charge disable signal in a case where the second voltage is greater than the second predetermined value, to control the first charge circuit 64 and the second charge circuit 65 to be simultaneously turned off to cease to charge the first energy store and the second energy store.

It is to be understood that, in some embodiments, the first predetermined value may be set to be less than the second predetermined value. In this case, according to the control logic of the voltage conversion circuit, the voltages across the first energy store, the second energy store, and the third energy store are stabilized between the first predetermined value and the second predetermined value, which means that the output of the voltage conversion circuit is stabilized within a target range.

In some embodiments, the first predetermined value may be set to be equal to the second predetermined value. In this case, according to the control logic of the voltage conversion circuit, the voltages across the first energy store, the second energy store, and the third energy store are stabilized at a target value.

Still referring to FIG. 13, the first charge circuit 64 includes a first current source IGM1, a first transistor Q1, a second transistor Q2, a third transistor Q3, and a fourth transistor Q4. A positive terminal of the first current source IGM1 is electrically connected to a second power supply AVDD2, a negative terminal of the first current source IGM1 is electrically connected to a first terminal of the first transistor Q1, a second terminal of the first transistor Q1 is electrically connected to a first terminal of the third transistor Q3, a second terminal of the third transistor Q3 is grounded, a control terminal of the third transistor Q3 is electrically connected to a control terminal of the fourth transistor Q4, a first terminal of the fourth transistor Q4 is electrically connected to a second terminal of the first energy store, a second terminal of the fourth transistor Q4 is grounded (connected to a reference ground AVSS), a first terminal of the second transistor Q2 is electrically connected to a second terminal of the first transistor Q1, a second terminal of the second transistor Q2 is grounded, a control terminal of the first transistor Q1 and a control terminal of the second transistor Q2 are both configured to receive the first charge control signal and the third charge control signal.

Generally, the second charge circuit 65 and the first charge circuit 64 have the same or similar circuit structure. For example, still referring to FIG. 13, the second charge circuit 65 includes a second current source IMG21, a fifth transistor Q5, a sixth transistor Q6, a seventh transistor Q7, and an eighth transistor Q8. A positive terminal of the second current source IGM21 is electrically connected to the second power supply AVDD2, a negative terminal of the second current source IGM21 is electrically connected to a first terminal of the fifth transistor Q5, a second terminal of the fifth transistor Q5 is electrically connected to a first terminal of the seventh transistor Q7, a second terminal of the seventh transistor Q7 is grounded, a control terminal of the seventh transistor Q7 is electrically connected to a control terminal of the eighth transistor Q8, a first terminal of the eighth transistor Q8 is electrically connected to a second terminal of the second energy store, a second terminal of the eighth transistor Q8 is grounded (connected to the reference ground AVSS), a first terminal of the sixth transistor Q6 is electrically connected to a second terminal of the fifth transistor Q5, a second terminal of the sixth transistor Q6 is grounded, a control terminal of the fifth transistor Q5 and a control terminal of the sixth transistor Q6 are both configured to receive the second charge control signal and the third charge control signal.

In some embodiments, the first transistor Q1 and the fifth transistor Q5 in FIG. 13 are both PMOSFETs, wherein first terminals of the transistors are sources, second terminals of the transistors are drains, and control terminals of the transistors are gates; and the second transistor Q2, the third transistor Q3, the fourth transistor Q4, the sixth transistor Q6, the seventh transistor Q7, and the eighth transistor Q8 in FIG. 13 are all NMOSFETs, wherein first terminals of the transistors are drains, second terminals of the transistors are sources, and control terminals of the transistors are gates.

For example, referring to FIG. 13, the control terminal of the first transistor Q1 and the control terminal of the second transistor Q2 are both configured to receive a control signal EN_IGM1. The control signal EN_IGM1 is the first charge control signal or the third charge control signal. The control terminal of the fifth transistor Q5 and the control terminal of the sixth transistor Q6 are both configured to receive a control signal EN_IGM2. The control signal EN_IGM2 is the second charge control signal or the third charge control signal.

An amplification factor between the third transistor Q3 and the fourth transistor Q4 is N, and an amplification factor between the seventh transistor Q7 and the eighth transistor Q8 is also N.

It is apparent that, the embodiments directly employ open-loop control, wherein current signals output by the first current source IGM1 and the second current source IGM21 are directly amplified N times and then used to charge the first capacitor C1 and the second capacitor C2. Generally, the circuit is configured such that N×IGM1>N×IGM21>2×I_{load}, to prevent a situation where the first capacitor C1 and the second capacitor C2 never fails to be charged to a target value. Additionally, the embodiments include current limiting resistors R1 to R5 to prevent excessive currents, which could be generated during various transient behaviors such as voltage jumps of the first power supply VS_PAD1, from damaging electronic devices or elements in the circuit.

In the embodiments, the first charge control signal, the second charge control signal, and the third charge control signal are generated by the first charge control circuit 66, the second charge control circuit 67, and the third charge control circuit 68 respectively. Based on these signals, the voltages across the first energy store, the second energy store, and the third energy store are controlled to stabilize between the first predetermined value and the second predetermined value.

In some embodiments, still referring to FIG. 13, the first energy store may be the first capacitor C1, and the first energy storage circuit 61 further includes a ninth transistor Q9 and a tenth transistor Q10. A first terminal of the ninth transistor Q9 serves as the first terminal of the first energy storage circuit 61, a second terminal of the ninth transistor Q9 is electrically connected to the first terminal of the first capacitor C1, the second terminal of the first capacitor C1 serves as the second terminal of the first energy storage circuit 61, the second terminal of the first capacitor C1 is further electrically connected to a first terminal of the tenth transistor Q10, a second terminal of the tenth transistor Q10 is electrically connected to the first power supply VS_PAD1, and the second terminal of the first capacitor C1 is further electrically connected to an output terminal of the first charge circuit 64.

The second energy store may be the second capacitor C2, and the second energy storage circuit 62 further includes an eleventh transistor Q11; wherein a first terminal of the eleventh transistor Q11 is electrically connected to the first terminal of the first capacitor C1, a second terminal of the eleventh transistor Q11 is electrically connected to the first terminal of the second capacitor C2, and the second terminal of the second capacitor C2 is electrically connected to an output terminal of the second charge circuit 65. The first terminal of the eighth transistor Q8 serves as the output terminal of the second charge circuit 65.

The third energy store may be the third capacitor C3, and the third energy storage circuit 63 further includes a twelfth transistor Q12 and a thirteenth transistor Q13. A first terminal of the twelfth transistor Q12 is electrically connected to the first terminal of the second capacitor C2, a second terminal of the twelfth transistor Q12 is electrically connected to a first terminal of the third capacitor C3, a second terminal of the third capacitor C3 is electrically connected to a second terminal of the thirteenth transistor Q13, a first terminal of the thirteenth transistor Q13 is electrically connected to the second terminal of the second capacitor C2, and the first terminal and the third terminal of the third capacitor C3 form an output terminal of the third energy storage circuit 63. The output terminal of the third energy storage circuit 63 is configured to be electrically connected to a load I_{load}.

A control terminal of the ninth transistor Q9, a control terminal of the tenth transistor Q10, a control terminal of the eleventh transistor Q11, a control terminal of the twelfth transistor Q12, and a control terminal of the thirteenth transistor Q13 are configured to receive their respective switch drive signals. The switch drive signals are respectively used to control the ninth transistor Q9, the tenth transistor Q10, the eleventh transistor Q11, the twelfth transistor Q12, and the thirteenth transistor Q13 to be turned on or turned off.

In some embodiments, the ninth transistor Q9, the tenth transistor Q10, the eleventh transistor Q11, the twelfth transistor Q12, and the thirteenth transistor Q13 in FIG. 13 are all PMOSFETs, wherein first terminals of the transistors are drains, second terminals of the transistors are sources, and control terminals of the transistors are gates.

In some embodiments, each of the first energy storage circuit 61, the second energy storage circuit 62, and the third energy storage circuit 63 further includes a current limiting apparatus or device to prevent an over-large current in the circuit which may damage electronic devices in the circuit.

Still referring to FIG. 13, in some embodiments, the first energy storage circuit 61 further includes a first resistor R1 and a second resistor R2. The second terminal of the ninth transistor Q9 is electrically connected to a first terminal of the first resistor R1, a second terminal of the first resistor R1 is electrically connected to the first terminal of the first capacitor C1, the second terminal of the tenth transistor Q10 is electrically connected to a first terminal of the second resistor R2, and a second terminal of the second resistor R2 is electrically connected to the first power supply VS_PAD1. The first resistor R1 and the second resistor R2 achieve a current limiting effect in the first energy storage circuit 61. The second energy storage circuit 62 further includes a third resistor R3. The first terminal of the eleventh transistor Q11 is electrically connected to a first terminal of the third resistor R3, and a second terminal of the third resistor R3 is electrically connected to the first terminal of the second capacitor C2. The third resistor R3 achieves a current limiting effect in the second energy storage circuit 62. The third energy storage circuit 63 further includes a fourth resistor R4 and a fifth resistor R5. The second terminal of the twelfth transistor Q12 is electrically connected to a first terminal of the fourth resistor R4, a second terminal of the fourth resistor R4 is electrically connected to the first terminal of the third capacitor C3, the second terminal of the third capacitor C3 is electrically connected to a first terminal of the fifth resistor R5, and a second terminal of the fifth resistor R5 is electrically connected to the second terminal of the thirteenth transistor Q13. The fifth resistor R5 also achieves a current limiting effect in the third energy storage circuit 63.

The voltage conversion circuit operates under the control of dual-phase non-overlapping clock signals PH1 and PH2, as illustrated in FIG. 4. In a case where the clock signal PH1 is at a high level, the ninth transistor Q9, the twelfth transistor Q12, and the thirteenth transistor Q13 are turned on, whereas the eleventh transistor Q11 and the tenth transistor Q10 are turned off. Under these conditions, the first power supply VS_PAD1 charges the first capacitor C1, and the second capacitor C2 charges the third capacitor C3. In a case where the clock signal PH2 is at a high level, the ninth transistor Q9, the twelfth transistor Q12, and the thirteenth transistor Q13 are turned off, whereas the eleventh transistor Q11 and the tenth transistor Q10 are turned on. Under these conditions, the first capacitor C1 charges the second capacitor C2, and the third capacitor C3 supplies power to the load I_{load}.

Referring to FIG. 14, the first charge control circuit 66 includes a first voltage sampling circuit VDET1 and a first hysteresis comparator circuit CMP11. The first voltage sampling circuit VDET1 is configured to sample the first voltage across the first energy store. The first hysteresis comparator circuit CMP11 is configured to compare the first voltage with a corresponding predetermined value Vref, and generate the first charge control signal CP1_OVP1 based on a comparison result. The second charge control circuit 67 includes a second voltage sampling circuit VDET2 and a second hysteresis comparator circuit CMP12. The second voltage sampling circuit 67 is configured to sample the second voltage across the second energy storage device. The second hysteresis comparator circuit CMP12 is configured to compare the second voltage with the corresponding predetermined value Vref, and generate the second charge control signal CP2_OVP1 based on a comparison result. The third charge control circuit 68 includes a third voltage sampling circuit VDET3 and a third hysteresis comparator circuit CMP13. The third voltage sampling circuit VDET3 is configured to sample the third voltage across the third energy store. The second hysteresis comparator circuit CMP13 is configured to compare the second voltage with the corresponding predetermined value Vref, and generate the third charge control signal CP3_OVP1 based on a comparison result.

It is to be understood that since the first voltage sampling circuit, the second voltage sampling circuit, and the third voltage sampling circuit implement the same functionality, the first hysteresis comparator circuit, the second hysteresis comparator circuit, and the third hysteresis comparator circuit also implement the same functionality, in some embodiments, the first voltage sampling circuit, the second voltage sampling circuit, and the third voltage sampling circuit have a same circuit structure, and the first hysteresis comparator circuit, the second hysteresis comparator circuit, and the third hysteresis comparator circuit have a same circuit structure;

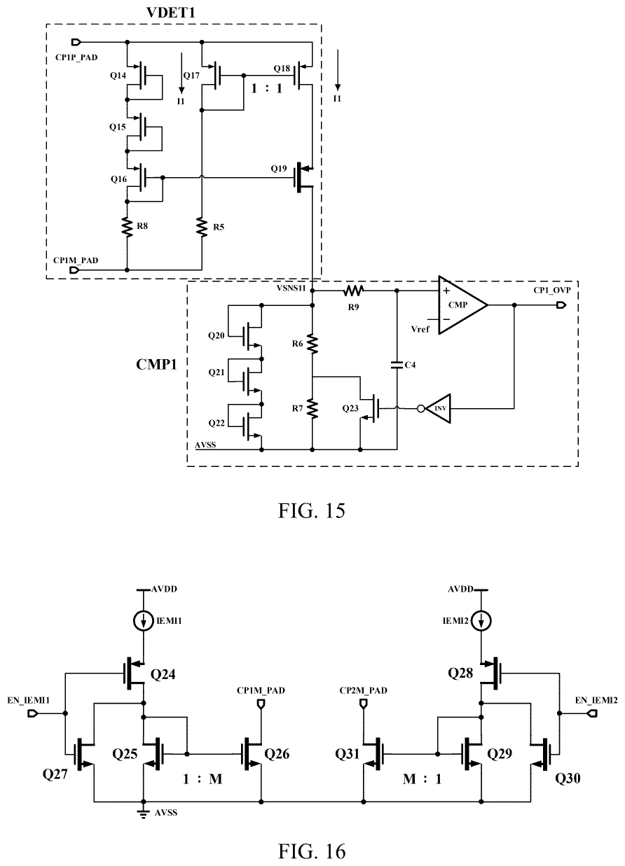

Using the structure of the first charge control circuit 66 as an example, in the embodiments hereinafter, the structure and function of the first charge control circuit are described. FIG. 15 is a schematic structural diagram of a first charge control circuit according to some embodiments of the present disclosure. Referring to FIG. 15, the first voltage sampling circuit 66 includes a fourteenth transistor Q14, a fifteenth transistor Q15, a sixteenth transistor Q16, a seventeenth transistor Q17, an eighteenth transistor Q18, a tenth transistor Q19, and a fifth resistor R5. A first terminal of the fourteenth transistor Q14 is electrically connected to a first terminal of the first energy store, a second terminal of the fourteenth transistor Q14 is electrically connected to a first terminal of the fifteenth transistor Q15, a second terminal of the fifteenth transistor Q15 is electrically connected to a first terminal of the sixteenth transistor Q16, a second terminal of the sixteenth transistor Q16 is electrically connected to a second terminal of the first energy store, a control terminal and a second terminal of the fourteenth transistor Q14 are short-circuited, a control terminal and the second terminal of the fifteenth transistor Q15 are short-circuited, and a control terminal and the second terminal of the sixteenth transistor Q16 are short-circuited. A first terminal of the seventeenth transistor Q17 is electrically connected to the first terminal of the first energy store, a second terminal of the seventeenth transistor Q17 is electrically connected to a first terminal of the fifth resistor R5, a second terminal of the fifth resistor R5 is electrically connected to a second terminal of the first energy store, and a control terminal and a second terminal of the seventeenth transistor Q17 are short-circuited. A first terminal of the eighteenth transistor Q18 is electrically connected to the first terminal of the seventeenth transistor Q17, a control terminal of the eighteenth transistor Q18 is electrically connected to the control terminal of the seventeenth transistor Q17, a second terminal of the eighteenth transistor Q18 is electrically connected to a first terminal of the nineteenth transistor Q19, a control terminal of the nineteenth transistor Q19 is electrically connected to the control terminal of the sixteenth transistor Q16, and a second terminal of the nineteenth transistor Q19 serves as an output terminal of the first voltage sampling circuit VDET1.

The first hysteresis comparator circuit CMP11 includes a twentieth transistor Q20, a twenty-first transistor Q21, a twenty-second transistor Q22, a twenty-third transistor Q23, a sixth resistor R6, a seventh resistor R7, a fourth capacitor C4, a comparator CMP, and an inverter INV. A first terminal of the twentieth transistor Q20 is electrically connected to the output terminal of the first voltage sampling circuit, the first terminal and a control terminal of the twentieth transistor Q20 are short-circuited, a second terminal of the twentieth transistor Q20 is electrically connected to a first terminal of the twenty-first transistor Q21, the first terminal and a control terminal of the twenty-first transistor Q21 are short-circuited, a second terminal of the twenty-first transistor Q21 is electrically connected to a first terminal of the twenty-second transistor Q22, the first terminal and a control terminal of the twenty-second transistor Q22 are short-circuited, and a second terminal of the twenty-second transistor Q22 is grounded. A first terminal of the sixth resistor R6 is electrically connected to the output terminal of the first voltage sampling circuit VDET1, a second terminal of the sixth resistor R6 is electrically connected to a first terminal of the seventh resistor R7, a second terminal of the seventh resistor R7 is grounded, the first terminal of the sixth resistor R6 is electrically connected to a non-inverting input terminal of the comparator CMP, an inverting input terminal of the comparator CMP is configured to receive a predetermined value Vref (which may be understood as a reference voltage), and an output terminal of the comparator CMP serves as an output terminal of the first hysteresis comparator circuit and is configured to output the first charge control signal CP_OVP1. The comparator CMP is a hysteresis comparator. A first terminal of the fourth capacitor C4 is electrically connected to the non-inverting input terminal of the comparator CMP, a second terminal of the fourth capacitor C4 is grounded, a first terminal of the twenty-third transistor Q23 is electrically connected to the first terminal of the seventh resistor R7, a second terminal of the twenty-third transistor Q23 is electrically connected to the second terminal of the seventh resistor R7, the output terminal of the comparator CMP is electrically connected to an input terminal of the inverter INV, and an output terminal of the inverter INV is electrically connected to a control terminal of the twenty-third transistor Q23.

In some embodiments, the fourteenth transistor Q14, the fifteenth transistor Q15, the sixteenth transistor Q16, the seventeenth transistor Q17, the eighteenth transistor Q18, and the nineteenth transistor Q19 in FIG. 15 are all PMOSFETs, wherein first terminals of the transistors are sources, second terminals of the transistors are drains, and control terminals of the transistors are gates; and the twentieth transistor Q20, the twenty-first transistor Q21, the twenty-second transistor Q22, and the twenty-third transistor Q23 in FIG. 15 are all NMOSFETs, wherein first terminals of the transistors are drains, second terminals of the transistors are sources, and control terminals of the transistors are gates.

In some embodiments, the first voltage sampling circuit VDET1 further includes an eighth resistor R8 and a ninth resistor R9. The second terminal of the sixteenth transistor Q16 is electrically connected to a first terminal of the eighth resistor R8, a second terminal of the eighth resistor R8 is electrically connected to the second terminal of the first energy store, the first terminal of the sixth resistor R6 is electrically connected to a first terminal of the ninth resistor R9, and a second terminal of the ninth resistor R9 is electrically connected to the non-inverting input terminal of the comparator CMP.

Under some specific operating conditions, the first predetermined value V1 may be set to 13.5, and the second predetermined value V2 may be set to 14.5. Still referring to FIG. 15, the operating process of the first charge control circuit 66 is described hereinafter using one operating cycle as an example.

In a case where a voltage difference VCP1 between CPIP_PAD and CPIM_PAD is less than V1 (i.e., VCP1<V1), the voltage difference VCP1 is converted into a current I1 via the seventeenth transistor Q17 and the fifth resistor R5, wherein I1=(VCP1−VGS_Q17)/R5. Herein, VGS_Q17 represents a voltage between the first terminal and the second terminal of the seventeenth transistor Q17. For example, VGS_Q17 may be a gate-source voltage of the seventeenth transistor Q17. In this case, the comparator CMP outputs the first charge control signal CP1_OVP1 as a low level, such that the twenty-third transistor Q23 is turned on, thereby short-circuiting the seventh resistor R7. The eighteenth transistor Q18 converts the current I1 from the seventeenth transistor Q17 at a 1:1 ratio to obtain a new current, which is equal to the current I1, and transmits the current I1 to the sixth resistor R6, converting the current I1 into a first detection voltage VSNS11. In this case, VSNS11=I1×R7=(VCP1−VGS_Q17)×R6/R5. In this way, a threshold voltage (i.e., the first predetermined value V1) for the comparator CMP is acquired. In this case,

$$V 1 = ( R 5 / R 6 ) \times V ref + VGS\_Q17 .$$

In a case where the voltage difference VCP1 between CPIP_PAD and CPIM_PAD is greater than V2 (i.e., VCP1>V2), the voltage difference VCP1 is converted into the current I1 via the seventeenth transistor Q17 and the fifth resistor R5, wherein I1=(VCP1−VGS_Q17)/R5. In this case, the comparator CMP outputs the first charge control signal CP1_OVP1 as a high level, such that the twenty-third transistor Q23 is turned off. The eighteenth transistor Q18 converts the current I1 from the seventeenth transistor Q17 at a 1:1 ratio to obtain a new current, which is equal to the current I1, and transmits the current I1 to the sixth resistor R6, converting the current I1 into the first detection voltage VSNS11. In this case, VSNS11=I1×R7−(VCPX−VGS_Q17)× (R6+R7)/R5. In this way, a threshold voltage (i.e., the second predetermined value V1) for the comparator CMP is acquired. In this case, V2=R5/(R6+R7)×Vref+VGS_Q17.

In a case where the voltage difference VCP1 between CP1P_PAD and CPIM_PAD is less than V1 (i.e., VCP1<V1), the first charge control signal CP1_OVP output by the comparator CMP transitions to a low level, such that the twenty-third transistor Q23 is turned on, thereby short-circuiting the seventh resistor R7. In this way, the first charge control circuit 66 is switched back to the first predetermined value V1.

The fourteenth transistor Q14, the fifteenth transistor Q15, the sixteenth transistor Q16, and the eighth resistor R8 supplies a bias voltage to the nineteenth transistor Q19 having a withstand voltage of 60 V; and the transistors Q14 to Q19, the resistors R5 and R8 are all placed in a 60-V high-voltage well. The transistors Q20 and Q21 clamps the first detection voltage VSNS11. During normal steady-state operation, these transistors are inactive. However, in a case where a transient jump occurs at CP1P_PAD or CP1M_PAD, causing an instantaneous high voltage at the node of the first detection voltage VSNS11, the transistors Q20 and Q21 clamp the first detection voltage VSNS11. The ninth resistor R9 and the fourth capacitor C4 form a low-pass filter. The signal acquired subsequent to filtering ripples from the first detection voltage VSNS11 is transmitted to the comparator CMP, thereby preventing erroneous state transitions of the comparator CMP due to significant ripples.

It is apparent that, in the embodiments, based on the Bang-Bang control concept, the first charge circuit 64, the second charge circuit 65, the first charge control circuit 66, the second charge control circuit 67, and the third charge control circuit 68 are provided to replace the control loop employing an error amplifier EA in the related art. In this way, the charge current is supplied by the first current source IGM1 and the second current source IGM21, but is no longer controlled by an error amplifier EA, such that the control precision and stability of the voltage conversion circuit are improved.

In some embodiments, to overcome the electromagnetic interference problems that may be caused by oscillation cessation of the first capacitor C1, the second capacitor C2, and the third capacitor C3, the voltage conversion circuit according to the embodiments further includes an electromagnetic interference eliminating circuit. The electromagnetic interference eliminating circuit is configured to eliminate electromagnetic interference signals in the first energy storage circuit 61, the second energy storage circuit 62, and the third energy storage circuit 63. Generally, the electromagnetic interference eliminating circuit includes a first output terminal and a second output terminal. The first output terminal of the electromagnetic interference eliminating circuit is electrically connected to the second terminal of the first energy store, and the second output terminal of the electromagnetic interference eliminating circuit is electrically connected to the second terminal of the second energy store.

FIG. 16 is a schematic structural diagram of an electromagnetic interference suppression circuit according to some embodiments of the present disclosure. Referring to FIG. 16, the electromagnetic interference eliminating circuit includes a twenty-fourth transistor Q24, a twenty-fifth transistor Q25, a twenty-sixth transistor Q26, a twenty-seventh transistor Q27, a twenty-eighth transistor Q28, a twenty-ninth transistor Q29, a thirtieth transistor Q30, a thirty-first transistor Q31, a third current source IEMI1, and a fourth current source IEMI2. A positive terminal of the third current source IEMI1 is electrically connected to the second power supply AVDD2, a negative terminal of the third current source IEMI1 is electrically connected to a first terminal of the twenty-fourth transistor Q24, a second terminal of the twenty-fourth transistor Q24 is electrically connected to a first terminal of the twenty-fifth transistor Q25, the first terminal and a control terminal of the twenty-fifth transistor Q25 are short-circuited, a second terminal of the twenty-fifth transistor Q25 is grounded, a first terminal of the twenty-sixth transistor Q26 serves as the first output terminal of the electromagnetic interference eliminating circuit, a second terminal of the twenty-sixth transistor Q26 is grounded, a control terminal of the twenty-sixth transistor Q26 is electrically connected to a control terminal of the twenty-fifth transistor Q25, a first terminal of the twenty-seventh transistor Q27 is electrically connected to the second terminal of the twenty-fourth transistor Q24, a second terminal of the twenty-seventh transistor Q27 is grounded, and a control terminal of the twenty-fourth transistor Q24 and a control terminal of twenty-seventh transistor Q27 are both configured to receive a fourth charge control signal EN_IEMI1, wherein the fourth charge control signal EN_IEMI1 is used to control the twenty-fourth transistor Q24 and the twenty-seventh transistor Q27 to be turned on or turned off simultaneously.

In some embodiments, the twenty-fourth transistor Q24 and the twenty-eighth transistor Q28 in FIG. 16 are both PMOSFETs, wherein first terminals of these transistors are sources, second terminals of these transistors are drains, and control terminals of these transistors are gates; and the twenty-fifth transistor Q25, the twenty-sixth transistor Q26, the twenty-seventh transistor Q27, the twenty-eighth transistor Q28, the twenty-ninth transistor Q29, the thirtieth transistor Q30, and the thirty-first transistor Q31 in FIG. 16 are all NMOSFETs, wherein first terminals of these transistors are drains, second terminals of these transistors are sources, and control terminals of these transistors are gates.

A positive terminal of the fourth current source IEMI2 is electrically connected to the second power supply AVDD2, a negative terminal of the fourth current source IEMI2 is electrically connected to a first terminal of the twenty-eighth transistor Q28, a second terminal of the twenty-eighth transistor Q28 is electrically connected to a first terminal of the twenty-ninth transistor Q29, the first terminal and a control terminal of the twenty-ninth transistor Q29 are short-circuited, a second terminal of the twenty-ninth transistor Q29 is grounded, a first terminal of the thirty-first transistor Q31 serves as the first output terminal of the electromagnetic interference eliminating circuit, a second terminal of the thirty-first transistor Q31 is grounded, a control terminal of the thirty-first transistor Q31 is electrically connected to the control terminal of the twenty-ninth transistor Q29, a first terminal of the thirtieth transistor Q30 is electrically connected to the second terminal of the twenty-eighth transistor Q28, a second terminal of the thirtieth transistor Q30 is grounded, and a control terminal of the twenty-eighth transistor Q28 and a control terminal of the thirtieth transistor Q30 are both configured to receive a fifth charge control signal EN_IEMI2, wherein the fifth charge control signal EN_IEMI2 is used to control the twenty-eighth transistor Q28 and the thirtieth transistor Q30 to be simultaneously turned on or turned off.

An amplification factor between a twenty-fifth transistor Q25 and a twenty-sixth transistor Q26 is M, and an amplification factor between a twenty-ninth transistor Q29 and a thirtieth transistor Q30 is also M.

Upon startup of the voltage conversion circuit, control signals EN_IEMI1 and EN_IEMI2 are constantly held at a low level, and currents output by the third current source IEMI1 and the fourth current source IEMI2 are amplified by M times to respectively charge the first capacitor C1 and the second capacitor C2. In the embodiments, the circuit needs to be configured such that M×IEMI1<2×I_{load_min} and M×IEMI2<2×I_{load_min}, wherein I_{load_min} represents a minimum required load value for the circuit. This configuration ensures that in a case where the first current source IGM1 and the second current source IGM21 are turned off, the voltages across the first capacitor C1, the second capacitor C2, and the third capacitor C3 may be pulled low, such that electromagnetic interference in the circuit is eliminated.

Still referring to FIG. 13, in some embodiments, the voltage conversion circuit further includes a first drive circuit DRV1, a second drive circuit DRV2, a third drive circuit DRV3, a fourth drive circuit DRV4, and a fifth drive circuit DRV5.

The first drive circuit DRV1, the second drive circuit DRV2, the third drive circuit DRV3, the fourth drive circuit DRV4, and the fifth drive circuit DRV5 are configured to receive their respective switch control signals respectively. For example, the first drive circuit DRV1, the second drive circuit DRV2, the third drive circuit DRV3, the fourth drive circuit DRV4, and the fifth drive circuit DRV5 are configured to receive a first switch control signal SW11, a second switch control signal SW12, a third switch control signal SW13, a fourth switch control signal SW14, and a fifth switch control signal SW15 respectively. Output terminals of the first drive circuit DRV1, the second drive circuit DRV2, the third drive circuit DRV3, the fourth drive circuit DRV4, and the fifth drive circuit DRV5 are respectively electrically connected to the control terminals of the ninth transistor Q9, the tenth transistor Q10, the eleventh transistor Q11, the twelfth transistor Q12, and the thirteenth transistor Q13. The first drive circuit DRV1, the second drive circuit DRV2, the third drive circuit DRV3, the fourth drive circuit DRV4, and the fifth drive circuit DRV5 are configured to generate their respective switch control signals based on the switch control signals respectively, to control the ninth transistor Q9, the tenth transistor Q10, the eleventh transistor Q11, the twelfth transistor Q12, and the thirteenth transistor Q13 to be turned on or turned off respectively.

Some embodiments further provide a charge pump. The charge pump includes the voltage conversion circuit as described above. The operating process and functional effects of the charge pump according to the embodiments may be understood by reference to the voltage conversion circuit, which are not described herein any further.

In some embodiments, the charge pump further includes a logic control circuit. The logic control circuit includes a plurality of enable terminals. The plurality of enable terminals are respectively electrically connected to the input terminals of the first drive circuit DRV1, the second drive circuit DRV2, the third drive circuit DRV3, the fourth drive circuit DRV4, and the fifth drive circuit DRV5 in the voltage conversion circuit. The logic control circuit is configured to, under dual-phase non-overlapping clock signals, output their respective control signals to control corresponding drive circuits to generate their respective switch drive signals. The switch drive signals are configured to control their respective transistors to be turned on or turned off respectively, thereby implementing the functionality of the charge pump.

It is to be understood that, in some embodiments, in addition to the voltage conversion circuit and the logic control circuit, the charge pump may further include related peripheral circuits to implement the functionality of the charge pump, which are not described herein any further.

Some embodiments of the present disclosure further provide a chip. The chip includes the voltage conversion circuit as described above or the charge pump as described above. In other words, the voltage conversion circuit, the charge pump, or the related peripheral circuits are integrated into a single chip to facilitate direct use in electronic devices and improve the production efficiency of electronic devices. The operating process and functional effects of the chip according to the embodiments may be understood by reference to the voltage conversion circuit, which are not described herein any further.

Some embodiments further provide an electronic device. The electronic device includes the chip as described above.

It is to be understood that, in some other embodiments, in addition to the chip, the electronic device may further include related hardware such as a housing, a circuit board, a power supply, and communication interfaces, which are not described herein any further.

In the voltage conversion circuit in the related art, by acquiring a voltage at an output terminal of the voltage conversion circuit and comparing the voltage with a reference voltage, feedback control is applied to the circuit based on a voltage difference between the voltage and the reference voltage. The magnitude of the current of each energy storage circuit is mainly controlled based on the voltage difference, such that the voltage at the output terminal of the voltage conversion circuit is stabilized at a target value. However, since significant ripple signals are generated in a case where each energy storage circuit is switched between a charge state and a discharge state, the accuracy of the sampled output voltage is reduced due to the impacts of the ripples. Consequently, the precision of controlling the charge-discharge of the energy storage circuits based on the sampled output voltage is also affected. This leads to considerable variations in the loop gain and the GBW of the voltage conversion circuit, thereby resulting in poor stability of the voltage conversion circuit.

To overcome the defects in the related art, the present disclosure provides an inventive concept. In this concept, during acquiring the voltage at the output terminal of the voltage conversion circuit, the following steps are performed within each operating cycle: during a charge phase, acquiring a voltage across an energy storage circuit connected to a load; subsequently, during a discharge phase of the energy storage circuit, ceasing the acquisition step, and maintaining or holding the state of the voltage acquired during the charge phase using a zero-order hold (ZOH), and controlling the circuit based on the maintained or held voltage. In this way, continuous acquisition of the voltages of the energy storage circuits is free from any impacts from the ripples during the charge phase and discharge phase, such that the control accuracy and stability of the circuit are ensured.

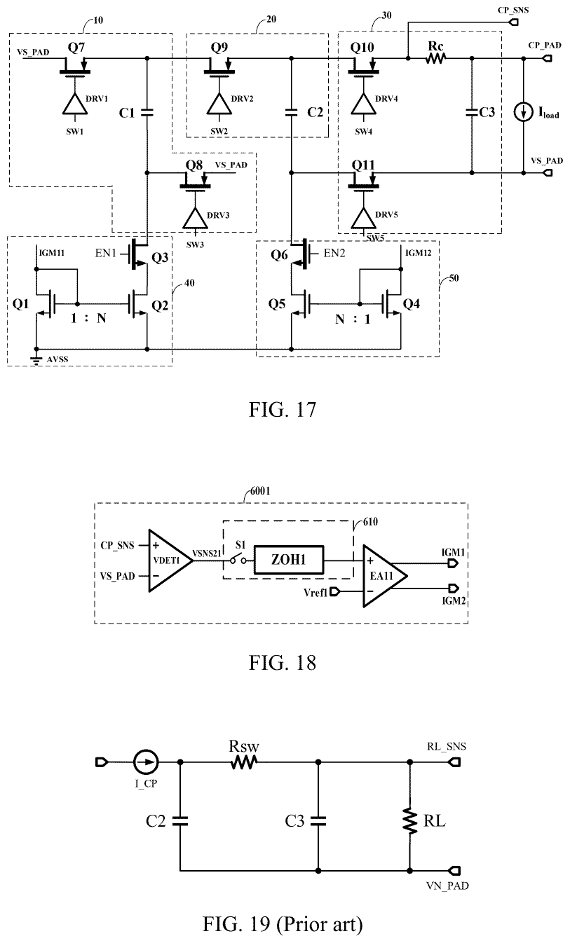

FIG. 17 is a schematic structural diagram of a voltage conversion circuit according to some embodiments of the present disclosure. Referring to FIG. 17, the voltage conversion circuit includes a first energy storage circuit 10, a second energy storage circuit 20, a third energy storage circuit 30, a first charge circuit 40, a second charge circuit 50, and a first feedback control circuit.

A first energy storage circuit 10, a second energy storage circuit 20, and a third energy storage circuit 30 are connected in parallel to each other. A first terminal of the first energy storage circuit 10 is configured to be connected to a power supply VS_PAD. Two terminals of the third energy storage circuit 30 are configured to be connected to a load I_{load}. A first charge circuit 40 is connected in series to the first energy storage circuit 10. The first charge circuit 40 is configured to supply a first charge current I1 to the first energy storage circuit 10, such that the first energy storage circuit 10 is charged to store energy. A second charge circuit 50 is connected in series to the second energy storage circuit 20. The second charge circuit 50 is configured to supply a second charge current I2 to the second energy storage circuit 20, such that the second energy storage circuit 20 is charged to store energy.

The first energy storage circuit 10, the second energy storage circuit 20, the third energy storage circuit 30, the first charge circuit 40, and the second charge circuit 50 are configured to receive their respective switch drive signals. The switch drive signals are respectively used to control the first energy storage circuit 10, the second energy storage circuit 20, the third energy storage circuit 30, the first charge circuit 40, and the second charge circuit 50 to be turned on or turned off, such that the first energy storage circuit 10, the second energy storage circuit 20, and the third energy storage circuit 30 are switched between a charge state and a discharge state respectively.

Specifically, the first charge circuit 40 and the second charge circuit 50 are configured to receive their respective switch control signals respectively. The switch control signals are respectively used to control the first charge circuit 40 and the second charge circuit 50 to be turned on or turned off. In this way, the first charge circuit 40 and the second charge circuit 50 are controlled to charge or not charge the first energy storage circuit 10 and the second energy storage circuit 20 respectively.

For example, in a case where the first charge circuit 40 receives a corresponding switch control signal that controls the first charge circuit 40 to be turned on, the first charge circuit 40 outputs a corresponding charge current to charge the first energy storage circuit 10, such that the first energy storage circuit 10 stores energy. In a case where the first charge circuit 40 receives a corresponding switch control signal that controls the first charge circuit 40 to be turned off, the first charge circuit 40 ceases to charge the first energy storage circuit 10, whereupon the first energy storage circuit 10 is switched to a discharge state. Correspondingly, the second charge circuit 50 is configured to receive a corresponding switch control signal that controls the second charge circuit 50 to be turned on, the second charge circuit 50 outputs a corresponding charge current to charge the second energy storage circuit 20, such that the second energy storage circuit 20 stores energy. In a case where the second charge circuit 50 receives a corresponding switch control signal that controls the second charge circuit 50 to be turned off, the second charge circuit 50 ceases to charge the second energy storage circuit 20, whereupon the second energy storage circuit 20 is switched to a discharge state.

Specifically, in the embodiments, the first energy storage circuit 10, the second energy storage circuit 20, and the third energy storage circuit 30 are configured to receive their respective switch drive signals respectively. The switch drive signals are used to respectively control the first energy storage circuit 10, the second energy storage circuit 20, and the third energy storage circuit 30 to be turned on or turned off, such that the first energy storage circuit 61, the second energy storage circuit 62, and the third energy storage circuit 63 are switched between a charge state and a discharge state respectively.

In the embodiments, using the first energy storage circuit 10 as an example for illustration, the first energy storage circuit 10 includes a plurality of transistors. Control terminals of the transistors are configured to receive their respective switch drive signals respectively, such that the transistors are controlled to be simultaneously turned on or turned off respective. This allows the first energy storage circuit 10 to form an energy storage loop, such that an energy storage device in the first energy storage circuit 10 is charged, and hence an energy store in the first energy storage circuit 10 completes energy storage.

The first feedback control circuit is configured to acquire a first voltage VSNS21 at an output terminal of the third energy storage circuit 30 in a case where the third energy storage circuit 30 is in a charge state, and adjust magnitudes of the first charge current I1 and the second charge current I2 based on the first voltage VSNS21. The first feedback control circuit includes a first zero-order hold, configured to maintain the voltage at the output terminal of the third energy storage circuit 30 to be the first voltage VSNS21 in a case where the third energy storage circuit 30 is in a discharge state.

In the voltage conversion circuit according to the present disclosure, to overcome the impacts of the ripples generated during switching of the third energy storage circuit 30 between the charge state and the discharge state on the control accuracy and stability of the circuit, within each operating period, the first voltage VSNS21 at the output terminal of the third energy storage circuit 30 is acquired in a case where the third energy storage circuit is in the charge state; whereas the voltage at the output terminal of the third energy storage circuit 30 does not need to be continuously acquired in a case where the third energy storage circuit is in the discharge state, and instead, the first voltage acquired in a case where the third energy storage circuit 30 is in the discharge state is maintained by the zero-order hold function of the first zero-order hold ZOH. In this way, the third energy storage circuit 30 is prevented from generating large ripples during switching between the charge state and the discharge state, such that accuracy of the acquired first voltage VSNS21 is not affected and thus accuracy of the first charge current I1 and the second charge current I2 is not affected. Ultimately, stability of the circuit is ensured.

Additionally, due to the impacts of the ripples, mis-trigger of the first feedback control circuit may also occur, i.e., the first feedback control circuit erroneously outputs a first current control signal IGM11 or a second current control signal IGM12, thereby affecting the stability of the voltage conversion circuit. By utilizing the first zero-order hold (ZOH) according to the embodiments, such ripples are avoided, such that mis-trigger of the first feedback control circuit is prevented and the overall stability of the voltage conversion circuit is ensured.

FIG. 18 is a schematic structural diagram of a first feedback control circuit provided by an embodiment of the present disclosure. Referring to FIG. 18, the first feedback control circuit 6001 includes a first voltage sampling circuit VDET1, a first switch S1, a first zero-order hold ZOH1, and a first error amplifier EA11.

The first voltage sampling circuit VDET1 is configured to, in a case where the third energy storage circuit 30 is in a charge state, sample a first voltage VSNS21 at an output terminal of the third energy storage circuit 30; the first Zero-Order Hold ZOH1 is configured to, in a case where the third energy storage circuit 30 is in a discharge state, hold the first voltage VSNS21 output by the first voltage sampling circuit VDET1; and the first error amplifier EA11 is configured to compare the first voltage VSNS21 with a first reference voltage Vref1, generate a difference therebetween, and amplify the difference to generate the first current control signal IGM11 and the second current control signal IGM12. The first current control signal IGM11 is used to control the first charge circuit 40 to adjust the magnitude of the first charge current I1, and the second current control signal IGM12 is used to control the second charge circuit 50 to adjust the magnitude of the second charge current I2.

The first switch S1 is connected in series between the first voltage sampling circuit VDET1 and the first zero-order hold ZOH1. The first switch S1 and the first zero-order hold ZOH1 form a first sample-and-hold circuit 610. In a case where the third energy storage circuit 30 is in the charge state, the first switch S1 is turned on, and the first voltage sampling circuit VDET1 transmits the sampled first voltage VSNS21 to the first zero-order hold ZOH1. In a case where the third energy storage circuit 30 is in the discharge state, the first switch S1 is turned off, and the first zero-order hold ZOH1 holds the first voltage VSNS21 sampled during the charge state, thereby obviating the need for continuous sampling during the charge-discharge processes.

In some embodiments, each of the first energy storage circuit 10, the second energy storage circuit 20, the third energy storage circuit 30, the first charge circuit 40, and the second charge circuit 50 includes at least one transistor. The transistors in these circuits are configured to receive their respective switch drive signals. The switch drive signals are respectively used to control the corresponding transistors to be turned on or turned off, such that the corresponding circuits are controlled to be turned on or turned off. In this way, the first energy storage circuit 10, the second energy storage circuit 20, and the third energy storage circuit 30 are switched between a charge state and a discharge state to output stable voltages.

Still referring to FIG. 17, the first charge circuit 40 includes a first transistor Q1, a second transistor Q2, and a third transistor Q3. A first terminal of the first transistor Q1 is configured to receive a first current control signal IGM11, wherein the first current control signal IGM11 is used to control the first charge circuit 40 to adjust a magnitude of the first charge current; a second terminal of the first transistor Q1 is grounded, the first terminal and a control terminal of the first transistor Q1 are short-circuited, and the control terminal of the first transistor Q1 is electrically connected to a control terminal of the second transistor Q2; a first terminal of the second transistor Q2 is electrically connected to a second terminal of the third transistor Q3, and a second terminal of the second transistor Q2 is grounded; and a first terminal of the third transistor Q3 is electrically connected to a second terminal of the first energy storage circuit 10, and the first terminal of the first energy storage circuit 10 is configured to be connected to the power supply VS_PAD.

The second charge circuit 50 includes a fourth transistor Q4, a fifth transistor Q5, and a sixth transistor Q6. A first terminal of the fourth transistor Q4 is configured to receive a second current control signal IGM12, wherein the second current control signal IGM12 is used to control the second charge circuit 50 to adjust a magnitude of the second charge current I2; a second terminal of the fourth transistor Q4 is grounded, the first terminal and a control terminal of the fourth transistor Q4 are short-circuited, and the control terminal of the fourth transistor Q4 is electrically connected to a control terminal of the fifth transistor Q5; and a second terminal of the fifth transistor Q5 is grounded, a first terminal of the fifth transistor Q5 is electrically connected to a second terminal of the sixth transistor Q6, and a first terminal of the sixth transistor Q6 is electrically connected to one terminal of the second energy storage circuit 20 and configured to output the second charge current I2 to the second energy storage circuit 20.

In some embodiments, the first transistor Q1, the second transistor Q2, the third transistor Q3, the fourth transistor Q4, the fifth transistor Q5, and the sixth transistor Q6 in FIG. 17 are all NMOSFETs, wherein first terminals of the transistors are drains, second terminals of the transistors are sources, and control terminals of the transistors are gates.

A control terminal of the third transistor Q3 and a control terminal of the sixth transistor Q6 are configured to receive their respective switch control signals respectively, wherein the switch control signals are respectively used to control the third transistor Q3 and the sixth transistor Q6 to be turned on or turned off. In this way, the first charge circuit 40 and the second charge circuit 50 are controlled to charge or not charge the first energy storage circuit 10 and the second energy storage circuit 20 respectively. For example, still referring to FIG. 1, the control terminal of the third transistor Q3 is configured to receive a switch control signal EN1, to control the third transistor Q3 to be turned on or turned off; and the control terminal of the sixth transistor Q6 is configured to receive a switch control signal EN2, to control the sixth transistor Q6 to be turned on or turned off.

The first transistor Q1 and the second transistor Q2 form a high-voltage current mirror circuit, and the fourth transistor Q4 and the fifth transistor Q5 also form another high-voltage current mirror circuit. An amplification factor between the first transistor Q1 and the second transistor Q2 is N, and an amplification factor between the fourth transistor Q4 and the fifth transistor Q5 is also N.

In the related art, the first charge circuit 40 and the second charge circuit 50 do not include the third transistor Q3 or the sixth transistor Q6. Therefore, the first transistor Q1, the second transistor Q2, the fourth transistor Q4, and the fifth transistor Q5 employ transistors with a relatively high withstand voltage. For example, based on a voltage level of the power supply VS_PAD, the first transistor Q1, the second transistor Q2, the fourth transistor Q4, and the fifth transistor Q5 are typically selected from high-voltage transistors with a withstand voltage of 45 V or higher. However, matching characteristics of high-voltage transistors are relatively poor, especially their sub-threshold matching in a case where a load current is small. This leads to larger deviations in the charge currents subsequent to N-times amplification by the two high-voltage current mirror circuits, thereby affecting the precision and stability of the circuit.

To overcome the technical defects, in the voltage conversion circuit according to the embodiments, the third transistor Q3 and the sixth transistor Q6 are added to the first charge circuit 40 and the second charge circuit 50 respectively. A withstand voltage of the third transistor Q3 is greater than a withstand voltage of each of the first transistor Q1 and the second transistor Q2. A withstand voltage of the sixth transistor Q6 is greater than a withstand voltage of each of the fourth transistor Q4 and the fifth transistor Q5. During the charge process, the third transistor Q3 and the sixth transistor Q6 may serve to block high voltages. In this case, the first transistor Q1, the second transistor Q2, the fourth transistor Q4, and the fifth transistor Q5 may be selected from industry-standard low-voltage transistors. Low-voltage transistors exhibit better stability and matching characteristics, and provide a precise N-times amplification functionality, such that the amplified first charge current I1 and second charge current I2 become more accurate and the stability of the circuit is improved.

In some embodiments, since both the third transistor Q3 and the sixth transistor Q6 are used for the purpose of blocking the high voltage of the power supply, the withstand voltages of the third transistor Q3 and sixth transistor Q6 are not less than the output voltage of the power supply. In this case, the first transistor Q1, the second transistor Q2, the fourth transistor Q4, and the fifth transistor Q5, which form the current mirror circuits, may be selected from transistors with a lower withstand voltage.

In a specific embodiment, the first transistor Q1, the second transistor Q2, the fourth transistor Q4, and the fifth transistor Q5 may be selected from complementary metal-oxide-semiconductor field-effect transistors (CMOSFETs) with a withstand voltage of approximately 5V. The third transistor Q3 and the sixth transistor Q6 may be selected from high-voltage tolerant transistors. For example, the third transistor Q3 and the sixth transistor Q6 may be selected from transistors with a withstand voltage of 40 V. Thus, during operation, the third transistor Q3 and the sixth transistor Q6 may serve to block the power supply VS_PAD, while ensuring that the output of the current mirror circuits is more precise.

Still referring to FIG. 17, the first energy storage circuit 10 includes a first capacitor C1, the second energy storage circuit 20 includes a second capacitor C2, and the third energy storage circuit 30 includes a third capacitor C3. The first capacitor C1, the second capacitor C2, and the third capacitor C3 are all used in the circuit for energy storage and discharge. The alternating charge-discharge of the first capacitor C1, the second capacitor C2, and the third capacitor C3 implements the operating process of the voltage conversion circuit.

In the related art, the voltage across the third capacitor C3 is sampled, i.e., the voltage between voltage sampling points CP_PAD and VS_PAD is sampled. Then, a first feedback control circuit outputs the first charge current I1 and the second charge current I2 with the sampled voltage as a reference. In this case, the first capacitor C1 is not within the overall circuit loop and only provides a charge current I_CP to an output stage.

FIG. 19 is a schematic structural diagram of an equivalent linear model for voltage conversion circuit in the related art. Referring to FIG. 19, a tenth transistor Q10 and an eleventh transistor Q11 may be considered equivalent to a resistor Rsw, and a load may be considered equivalent to a resistor RL. RL_SNS and VN_PAD are voltage sampling points across the resistor RL. Typically, in the voltage conversion circuit of the related art, a capacitor value of the CP is greater than that of the CP2, i.e., CP>CP2, and a resistance value of the RL is greater than that of the Rsw, i.e., RL>Rsw.

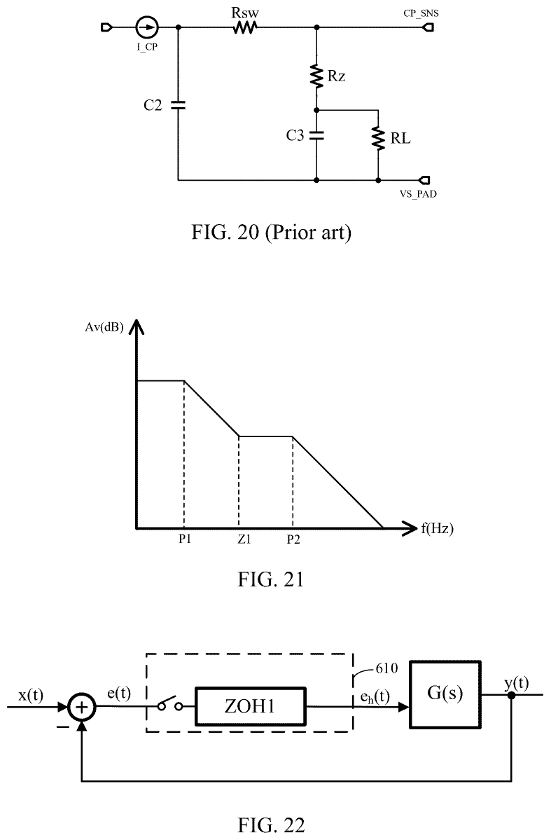

FIG. 20 is a Bode plot of an equivalent linear model for an output stage of a voltage conversion circuit in the related art. Referring to FIG. 20, the voltage conversion circuit in the related art may be initially approximated as a two-pole system, wherein P1 and P2 represent two poles in the circuit. These two poles may be respectively expressed as shown in formulas (1) and (2).

Under a specific operating condition, in a case where the resistance value of the equivalent resistance Rsw is relatively large, a frequency of the pole P2 is liable to be less than the GBW of the voltage conversion circuit, leading to degraded stability of the voltage conversion circuit. Furthermore, in the related art, the error amplifier EA1 exhibits a high low-frequency gain and possesses a low-frequency pole PEA. Consequently, a voltage conversion circuit for a charge pump employing such an error amplifier is substantially a three-pole system. Due to the inherent difficulty in compensating three-pole systems, the stability of such voltage conversion circuits in the related art is compromised.

To overcome the deficiencies in the related art, in the voltage conversion circuit according to the present disclosure, a compensation resistor Rc is introduced into the third energy storage circuit 30. The compensation resistor Rc, in turn, introduces a zero into the overall voltage conversion circuit, such that the voltage conversion circuit may be substantially equivalent to a single-pole system. This ensures the overall stability of the voltage conversion circuit.

Referring to FIG. 17, the third energy storage circuit 30 according to the embodiments includes a compensation resistor Rc. A first terminal of the second energy storage circuit 20 is electrically connected to a first terminal of the compensation resistor Rc, a second terminal of the compensation resistor Rc is electrically connected to a first terminal of the third capacitor C3, and a second terminal of the third capacitor C3 is electrically connected to a second terminal of the second energy storage circuit 20. The first feedback control circuit 6001 is configured to sample a voltage between the first terminal of the compensation resistor Rc and the second terminal of the third capacitor C3 as the first voltage VSNS21, i.e., to sample the voltage between voltage sampling points CP_SNS and VS_PAD as the first voltage VSNS21.

In the voltage conversion circuit according to the embodiments of the present disclosure, by adding the compensation resistor Rc, the overall voltage conversion circuit has a zero, such that the voltage conversion circuit includes two poles and one zero, and the circuit is substantially equivalent to a single-pole system. Since the single-pole system is readily controlled and compensated, the voltage conversion circuit according to the embodiments exhibits high overall stability.

Referring to FIG. 20, under typical conditions, C3>C2, and RL>Rz>Rsw. FIG. 21 is a Bode plot of an equivalent linear model for a voltage conversion circuit according to some embodiments of the present disclosure. Referring to FIG. 21, the voltage conversion circuit includes two poles (P1 and P2) and one zero (Z1), and may therefore be approximated as a single-pole system. The poles and the zero may be respectively expressed as formulas (3), (4), and (5):

It is apparent that, in the embodiments, the gain of the first error amplifier EA11 is relatively low, no high-frequency poles are present, and the poles of the first error amplifier EA11 are both set to frequencies significantly greater than the GBW of the circuit. This ensures that the voltage conversion circuit has a phase margin close to 90 degrees, exhibiting excellent stability.

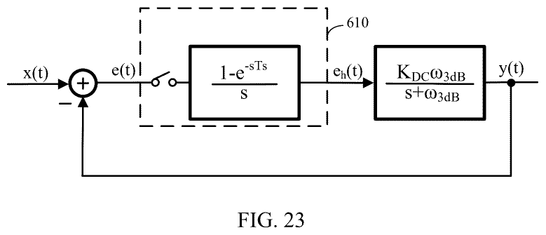

FIG. 22 is a schematic diagram of a sample-and-hold feedback system for a first sample-and-hold circuit according to some embodiments of the present disclosure. FIG. 23 is a schematic diagram of a zero-order sample-and-hold feedback system based on a single-pole system according to some embodiments of the present disclosure. Referring to FIG. 22 and FIG. 23, it is apparent that in a case where the first zero-order hold ZOH1 is added into the voltage conversion circuit, the operating loop of the sample-and-hold feedback system is as illustrated in FIG. 22. In FIG. 22, G(s) represents a transfer function of the sample-and-hold feedback system.

Due to the addition of the compensation resistor Rc in the embodiments, which introduces a zero into the voltage conversion circuit, the sample-and-hold feedback system may be equivalent to a single-pole system. The transfer function thereof may be expressed as:

$$G ( s ) = \frac{{K}_{DC} {ω}_{3 dB}}{s + {ω}_{3 dB}} \qquad Formula ( 6 )$$

In formula (6), K_{DC} represents a low-frequency gain of the sample-and-hold feedback system, ω_{3 dB} represents a −3 dB bandwidth of the sample-and-hold feedback system, and S represents a complex frequency domain.

With the induction of the first zero-order hold ZOH1, the transfer function of the sample-and-hold feedback system may be expressed as:

$$Z O H 1 ( s ) = \frac{1 - {e}^{- {sT}_{s}}}{s} \qquad Formula ( 7 )$$

In formula (7), Tₛ represents a sampling clock period, Tₛ=2π/ωₛ, and ωₛ represents a sampling clock frequency.

Assuming that s=jω, then the transfer function may be expressed as:

$$Z O H 1 ( s ) = {T}_{s} Sa ( \frac{ω {T}_{s}}{2} ) {e}^{- j \frac{ω {T}_{s}}{2}} \qquad Formula ( 8 )$$

In formula (8), Sa represents a sampling function, wherein due to the introduction of the first zero-order hold ZOH1, the sample-and-hold feedback system exhibits an additional phase shift. This additional phase shift may be expressed by formula (9):

$${φ}_{h} ( ω ) = - \frac{ω {T}_{s}}{2} \qquad Formula ( 9 )$$

The phase of the additional phase shift is a lagging phase, which reduces the phase margin of the sample-and-hold feedback system, potentially leading to instability in the sample-and-hold feedback system.

The phase shift introduced by the first zero-order hold ZOH1 is linear in nature. Reducing the bandwidth of the sample-and-hold feedback system mitigates the impacts of the additional phase shift. Therefore, in the embodiments, ω=UGB may be selected, wherein UGB is far less than the sampling clock frequency Tₛ, and generally UGB<¼ωₛ, such that the sample-and-hold feedback system acquires a phase margin greater than 45°, thereby enhancing the stability of the sample-and-hold feedback system.

Still referring to FIG. 17, in some embodiments, the first energy storage circuit 10 further includes a seventh transistor Q7 and an eighth transistor Q8. A first terminal of the seventh transistor Q7 serves as the first terminal of the first energy storage circuit 10, a second terminal of the seventh transistor Q7 is electrically connected to the first terminal of the first capacitor C1, the second terminal of the first capacitor C1 serves as the second terminal of the first energy storage circuit 10, the second terminal of the first capacitor is further electrically connected to the first terminal of the eighth transistor Q8, and a second terminal of the eighth transistor Q8 is electrically connected to the power supply VS_PAD.

The second energy storage circuit 20 further includes a ninth transistor Q9. A first terminal of the ninth transistor Q9 serves as the first terminal of the second energy storage circuit 20, the first terminal of the second energy storage circuit 20 is electrically connected to the first terminal of the first capacitor C1, a second terminal of the ninth transistor Q9 is electrically connected to the first terminal of the second capacitor C2, and the second terminal of the second capacitor C2 serves as the second terminal of the second energy storage circuit 20.

The third energy storage circuit 30 further includes a tenth transistor Q10 and an eleventh transistor Q11. A first terminal of the tenth transistor Q10 is electrically connected to the first terminal of the second capacitor C2, a second terminal of the tenth transistor Q10 is electrically connected to a first terminal of the third capacitor C3, a second terminal of the third capacitor C3 is electrically connected to a second terminal of the eleventh transistor Q11, a first terminal of the eleventh transistor Q11 is electrically connected to the second terminal of the second capacitor C2, and the first terminal and the second terminal of the third capacitor C3 form an output terminal of the third energy storage circuit 30.

A control terminal of the seventh transistor Q7, a control terminal of the eighth transistor Q8, a control terminal of the ninth transistor Q9, a control terminal of the tenth transistor Q10, and a control terminal of the eleventh transistor Q11 are configured to receive their respective switch drive signals. The switch drive signals are respectively used to control the seventh transistor Q7, the eighth transistor Q8, the ninth transistor Q9, the tenth transistor Q10, and the eleventh transistor Q11 to be turned on or turned off.

In some embodiments, the seventh transistor Q7, the eighth transistor Q8, the ninth transistor Q9, the tenth transistor Q10, and the eleventh transistor Q11 in FIG. 17 are all PMOSFETS, wherein first terminals of the transistors are drains, second terminals of the transistors are sources, and control terminals of the transistors are gates.

Still referring to FIG. 1, in some embodiments, the voltage conversion circuit further includes a first drive circuit DRV1, a second drive circuit DRV2, a third drive circuit DRV3, a fourth drive circuit DRV4, and a fifth drive circuit DRV5.

The first drive circuit DRV1, the second drive circuit DRV2, the third drive circuit DRV3, the fourth drive circuit DRV4, and the fifth drive circuit DRV5 are configured to receive their respective switch control signals. For example, the first drive circuit DRV1, the second drive circuit DRV2, the third drive circuit DRV3, the fourth drive circuit DRV4, and the fifth drive circuit DRV5 are configured to receive a first switch control signal SW11, a second switch control signal SW12, a third switch control signal SW13, a fourth switch control signal SW14, and a fifth switch control signal SW15 respectively. Output terminals of the first drive circuit DRV1, the second drive circuit DRV2, the third drive circuit DRV3, the fourth drive circuit DRV4, and the fifth drive circuit DRV5 are respectively electrically connected to the control terminals of the seventh transistor Q7, the ninth transistor Q9, the eighth transistor Q8, the tenth transistor Q10, and the eleventh transistor Q11. The first drive circuit DRV1, the second drive circuit DRV2, the third drive circuit DRV3, the fourth drive circuit DRV4, and the fifth drive circuit DRV5 are configured to generate their respective switch control signals based on the switch control signals respectively, to control the seventh transistor Q7, the eighth transistor Q8, the ninth transistor Q9, the tenth transistor Q10, and the eleventh transistor Q11 to be turned on or turned off respectively.

Under dual-phase non-overlapping clock signals PH1 and PH2, as illustrated in FIG. 3, in a case where the clock signal PH1 is at a high level, the seventh transistor Q7, the tenth transistor Q10, and the eleventh transistor Q11 are controlled to be turned on, whereas the eighth transistor Q8 and the ninth transistor Q9 are controlled to be turned off, under these conditions, the power supply VS_PAD charges the first capacitor C1, and the second capacitor C2 charges the third capacitor C3. In a case where the clock signal PH2 is at a high level, the seventh transistor Q7, the tenth transistor Q10, and the eleventh transistor Q11 are all controlled to be turned off, whereas the eighth transistor Q8 and the ninth transistor Q9 which are previously turned off are now controlled to be turned on, under these conditions, the first capacitor C1 charges the second capacitor C2, and the third capacitor C3 supplies power to the load I_{load}.

For the first feedback control circuit 6001, in a case where the clock signal PH1 is at a high level, it is a sampling phase. In this case, the first feedback control circuit 6001 is operating, and the first voltage sampling circuit VDET1 is in a “sample” state, sampling the first voltage VSNS21 across the third capacitor C3. Simultaneously, the second capacitor C2 charges the third capacitor C3, and the power supply VS_PAD charges the first capacitor C1. In a case where PH2 is at a high level, it is a zero-order hold phase. In this case, the first feedback control circuit 6001 is not operating, and the first voltage sampling circuit VDET1 is in a “hold” state. By using the voltage across the third capacitor C3 sampled during the PH1 phase, the first capacitor C1 charges the second capacitor C2. Due to the use of the first zero-order hold ZOH1, during the phase where the clock signal PH2 is at a high level, the first voltage sampling circuit VDET1 no longer samples the voltage difference across the third capacitor C3, but instead holds the voltage difference across the third capacitor C3 that is sampled during the phase where the clock signal PH1 is at a high level. This therefore avoids the ripples that would be introduced by continuous sampling during the charge-discharge processes of the third capacitor C3, thereby preventing mis-triggering of the first voltage sampling circuit VDET1 and ensuring the stability of the voltage conversion circuit.

Some embodiments further provide a charge pump. The charge pump includes the voltage conversion circuit as described above. The operating process and functional effects of the charge pump according to the embodiments may be understood by reference to the voltage conversion circuit, which are not described herein any further.

In some embodiments, the charge pump further includes a logic control circuit. The logic control circuit includes a plurality of enable terminals. The plurality of enable terminals are respectively electrically connected to the input terminals of the first drive circuit DRV1, the second drive circuit DRV2, the third drive circuit DRV3, the fourth drive circuit DRV4, and the fifth drive circuit DRV5 in the voltage conversion circuit. The logic control circuit is configured to, under dual-phase non-overlapping clock signals, output their respective control signals to control corresponding drive circuits to generate their respective switch drive signals. The switch drive signals are configured to control their respective transistors to be turned on or turned off, thereby implementing the functionality of the charge pump.

It is to be understood that, in some embodiments, in addition to the voltage conversion circuit and the logic control circuit, the charge pump may further include related peripheral circuits to implement the functionality of the charge pump, which are not described herein any further.

Some embodiments of the present disclosure further provide a chip. The chip includes the voltage conversion circuit as described above or the charge pump as described above. In other words, the voltage conversion circuit, the charge pump, or the related peripheral circuits are integrated into a single chip to facilitate direct use in electronic devices and improve the production efficiency of electronic devices. The operating process and functional effects of the chip according to the embodiments may be understood by reference to the voltage conversion circuit, which are not described herein any further.

Some embodiments further provide an electronic device. The electronic device includes the chip as described above.

It is to be understood that, in some other embodiments, in addition to the chip, the electronic device may further include related hardware such as a housing, a circuit board, a power supply, and communication interfaces, which are not described herein any further.

It should be noted that, in this specification, terms “comprises,” “include,” “contain,” and any other variations thereof are intended to cover a non-exclusive inclusion, such that a process, method, article, or system, that comprises, has, includes, or contains a list of elements does not include only those elements but may include other elements not expressly listed or inherent to such process, method, article, or system. An element proceeded by “comprises . . . a,” “has . . . a,” “includes . . . a,” or “contains . . . a” does not, without more constraints, preclude the existence of additional identical elements in the process, method, article, or system.

It should be finally noted that the above embodiments are used only for illustrating the present disclosure, but are not intended to limit the protection scope of the present disclosure. Various modifications and replacements readily derived by those skilled in the art within technical content of the present disclosure shall fall within the protection scope of the present disclosure. Therefore, the protection scope of the present disclosure is subject to the appended claims.

What is claimed is:

1. A voltage conversion circuit, comprising: a first charge-discharge branch, a second charge-discharge branch, a third charge-discharge branch, a compensation resistor, a first current branch, and a second current branch; wherein
the first charge-discharge branch, the second charge-discharge branch, and the third charge-discharge branch are sequentially connected in parallel, the compensation resistor is electrically connected in series in the third charge-discharge branch, an input terminal of the first charge-discharge branch is electrically connected to a power supply, and an output terminal of the third charge-discharge branch is electrically connected to a load;
the first current branch and the second current branch are respectively connected in series in the first charge-discharge branch and the second charge-discharge branch, and configured to supply charge currents to the first charge-discharge branch and the second charge-discharge branch respectively; and
at least one transistor is arranged in each of the first charge-discharge branch, the second charge-discharge branch, the third charge-discharge branch, the first current branch, and the second current branch, wherein a control terminal of a transistor, which is one of the at least one transistor, is configured to receive a control signal to control a charge-discharge branch comprising the transistor to be turned on or turned off.

2. The voltage conversion circuit according to claim 1, wherein the voltage conversion circuit further comprises a fourth voltage sampling circuit; and
the third charge-discharge branch comprises a third capacitor;
wherein the compensation resistor and the third capacitor are connected in series, a sampling terminal of the fourth voltage sampling circuit is configured to acquire a fourth voltage across a series connection of the compensation resistor and the third capacitor and output a charge current subsequent to performing logic processing on the fourth voltage, and an output terminal of the fourth voltage sampling circuit is electrically connected to an input terminal of the second current branch and configured to input the charge current to the second current branch.

3. The voltage conversion circuit according to claim 2, wherein the first charge-discharge branch comprises a first capacitor, and the second charge-discharge branch comprises a second capacitor; and
the voltage conversion circuit further comprises a first voltage sampling circuit, a second voltage sampling circuit, and a third voltage sampling circuit; wherein
the first voltage sampling circuit is configured to acquire a first voltage across the first capacitor, and output a first control signal subsequent to performing logic processing on the first voltage, wherein the first control signal is used to control the first current branch to be turned on or turned off;
the second voltage sampling circuit is configured to acquire a second voltage across the second capacitor, and output a second control signal subsequent to performing logic processing on the second voltage, wherein the second control signal is used to control the second current branch to be turned on or turned off; and
the third voltage sampling circuit is configured to acquire a third voltage across the third capacitor, and output a third control signal subsequent to performing logic processing on the third voltage, wherein the third control signal is used to control the first charge-discharge branch, the second charge-discharge branch, the third charge-discharge branch, the first current branch, and the second current branch to be simultaneously turned on or turned off.

4. The voltage conversion circuit according to claim 3, wherein each of the first voltage sampling circuit, the second voltage sampling circuit, and the third voltage sampling circuit comprises a voltage acquisition module, a sample-and-hold circuit, and a comparator; wherein
an input terminal of the voltage acquisition module is a voltage sampling terminal, an output of the voltage acquisition module is electrically connected to an input terminal of the sample-and-hold circuit, an output terminal of the sample-and-hold circuit is electrically connected to a non-inverting input terminal of the comparator, and an inverting input terminal of the comparator is configured to receive a reference voltage signal;
the voltage acquisition module is configured to acquire a corresponding voltage signal;
the sample-and-hold circuit is configured to maintain a state of an acquired voltage signal; and
the comparator is configured to output a corresponding control signal subsequent to performing logic processing on the acquired voltage signal and the reference voltage signal.

5. The voltage conversion circuit according to claim 3, wherein each of the first voltage sampling circuit, the second voltage sampling circuit, and the third voltage sampling circuit comprises a voltage acquisition module, a sample-and-hold circuit, and a comparator; wherein
an input terminal of the voltage acquisition module is a voltage sampling terminal, an output of the voltage acquisition module is electrically connected to an input terminal of the sample-and-hold circuit, an output terminal of the sample-and-hold circuit is electrically connected to a non-inverting input terminal of the comparator, and an inverting input terminal of the comparator is configured to receive a reference voltage signal;
the voltage acquisition module is configured to acquire a corresponding voltage signal;
the sample-and-hold circuit is configured to maintain a state of an acquired voltage signal; and
the comparator is configured to output a corresponding control signal subsequent to performing logic processing on the acquired voltage signal and the reference voltage signal.

6. The voltage conversion circuit according to claim 3, wherein the first current branch comprises a first current source, a sixth transistor, and a seventh transistor, wherein an input terminal of the first current source is configured to receive an analog voltage, and an output terminal of the first current source is electrically connected to a first terminal of the sixth transistor, a control terminal of the sixth transistor is electrically connected to a control terminal of the seventh transistor, a first terminal of the seventh transistor serves as an output terminal of the first current branch and is electrically connected to a second terminal of the first capacitor, the first terminal of the sixth transistor is further electrically connected to the control terminal of the seventh transistor, and both a second terminal of the sixth transistor and a second terminal of the seventh transistor are grounded; and
the second current branch comprises an eighth transistor and a ninth transistor, wherein a first terminal of the ninth transistor serves as the input terminal of the second current branch and is configured to receive a charge current output from the fourth voltage sampling circuit, a control terminal of the ninth transistor is electrically connected to a control terminal of the eighth transistor, a first terminal of the eighth transistor serves as an output terminal of the second current branch and is electrically connected to a second terminal of the second capacitor, a first terminal of the ninth transistor is electrically connected to the control terminal of the eighth transistor, and both a second terminal of the eighth transistor and a second terminal of the ninth transistor are grounded.

7. The voltage conversion circuit according to claim 6, wherein the fourth voltage sampling circuit comprises a voltage acquisition module and an error amplifier; wherein
an input terminal of the voltage acquisition module serves as the sampling terminal of the fourth voltage sampling circuit, an output terminal of the voltage acquisition module is electrically connected to a non-inverting input terminal of the error amplifier, an inverting input terminal of the error amplifier is configured to receive a reference voltage signal, and an output terminal of the error amplifier serves as an output terminal of the fourth voltage sampling circuit and is connected to the first terminal of the ninth transistor;
the voltage acquisition module is configured to acquire a fourth voltage across a series connection of the compensation resistor and the third capacitor; and
the error amplifier is configured to amplify an error between the fourth voltage and the reference voltage signal and output a charge current to the second current branch.

8. The voltage conversion circuit according to claim 5, wherein the voltage conversion circuit further comprises a first drive circuit, a second drive circuit, a third drive circuit, a fourth drive circuit, and a fifth drive circuit, and the first charge-discharge branch further comprises a first transistor and a third transistor, the second charge-discharge branch further comprises a second transistor, and the third charge-discharge branch further comprises a fourth transistor and a fifth transistor; wherein
an output terminal of the first drive circuit is electrically connected to a control terminal of the first transistor, an output terminal of the second drive circuit is electrically connected to a control terminal of the second transistor, an output terminal of the third drive circuit is electrically connected to a control terminal of the third transistor, an output terminal of the fourth drive circuit is electrically connected to a control terminal of the fourth transistor, and an output terminal of the fifth drive circuit is electrically connected to a control terminal of the fifth transistor; and
input terminals of the first drive circuit, the second drive circuit, the third drive circuit, the fourth drive circuit, and the fifth drive circuit are configured to receive the control signals respectively and generate their respective switch drive signals based on the control signals respectively, wherein the switch drive signals are respectively used to control the first transistor, the second transistor, the third transistor, the fourth transistor, and the fifth transistor to be turned on or turned off.

9. The voltage conversion circuit according to claim 7, wherein the error amplifier comprises a tenth transistor, an eleventh transistor, a twelfth transistor, a thirteenth transistor, a fourteenth transistor, a fifteenth transistor, a sixteenth transistor, a seventeenth transistor, an eighteenth transistor, a nineteenth transistor, a twentieth transistor, a twenty-first transistor, a twenty-second transistor, a second current source, and a third current source; wherein
a first terminal of the tenth transistor is configured to receive an analog voltage, a second terminal of the tenth transistor is electrically connected to a first terminal of the seventeenth transistor, a second terminal of the seventeenth transistor is electrically connected to an input terminal of the second current source, an output terminal of the second current source is grounded, a first terminal of the eleventh transistor is configured to receive the analog voltage, a second terminal of the eleventh transistor is electrically connected to a first terminal of the eighteenth transistor, a second terminal of the eighteenth transistor is electrically connected to the input terminal of the second current source, a control terminal of the tenth transistor is electrically connected to a control terminal of the eleventh transistor, a control terminal of the seventeenth transistor is electrically connected to an output terminal of the sample-and-hold circuit, and a control terminal of the eighteenth transistor is configured to receive the reference voltage signal;
a first terminal of the twelfth transistor is configured to receive the analog voltage, and a second terminal and a control terminal of the twelfth transistor are both connected to a second terminal of the eleventh transistor;
a first terminal of the thirteenth transistor is configured to receive the analog voltage, a second terminal of the thirteenth transistor is electrically connected to an input terminal of the third current source, an output terminal of the third current source is grounded, a control terminal of the thirteenth transistor is electrically connected to the second terminal of the eleventh transistor, a first terminal and a control terminal of the nineteenth transistor are both electrically connected to a second terminal of the thirteenth transistor, and a second terminal of the nineteenth transistor is grounded;
a first terminal of the fourteenth transistor is configured to receive the analog voltage, a second terminal of the fourteenth transistor is electrically connected to a first terminal of the twentieth transistor, a control terminal of the fourteenth transistor is electrically connected to the second terminal of the eleventh transistor, a second terminal of the twentieth transistor is grounded, a control terminal of the twentieth transistor is electrically connected to the second terminal of the thirteenth transistor, a first terminal of the twenty-first transistor is electrically connected to a second terminal of the fourteenth transistor, a second terminal of the twenty-first transistor is grounded, a control terminal of the twenty-first transistor is electrically connected to a control terminal of the twenty-second transistor, and the control terminal of the twenty-first transistor is further electrically connected to the first terminal of the twenty-first transistor;
a first terminal of the fifteenth transistor is configured to receive the analog voltage, a second terminal of the fifteenth transistor is electrically connected to a first terminal of the twenty-second transistor, a control terminal of the fifteenth transistor is electrically connected to a control terminal of the sixteenth transistor, the control terminal of the fifteenth transistor is further electrically connected to the second terminal of the fifteenth transistor, and a second terminal of the twenty-second transistor is grounded; and
a first terminal of the sixteenth transistor is configured to receive the analog voltage, and a second terminal of the sixteenth transistor is configured to output the charge current.

10. A voltage conversion circuit, comprising: a first energy storage circuit, a second energy storage circuit, a third energy storage circuit, a first charge circuit, a second charge circuit, a first charge control circuit, and a second charge control circuit; wherein
the first energy storage circuit, the second energy storage circuit, and the third energy storage circuit are connected in parallel, a first terminal of the first energy storage circuit is electrically connected to a first power supply, and two terminals of the third energy storage circuit are electrically connected to a load;
the first energy storage circuit comprises a first energy store, and the second energy storage circuit comprises a second energy store, wherein the first energy store and the second energy store are both configured to store energy;
the first charge control circuit is configured to acquire a first voltage across the first energy store and generate a first charge control signal based on the first voltage;
the second charge control circuit is configured to acquire a second voltage across the second energy store and generate a second charge control signal based on the second voltage,
wherein the first charge control signal is used to control the first charge circuit to be turned on or turned off, and the second charge control signal is used to control the second charge circuit to be turned on or turned off;
the first charge circuit in an on state is configured to output a first charge current to the first energy storage circuit, and the second charge circuit in an on state is configured to output a second charge current to the second energy storage circuit; and
the first energy storage circuit, the second energy storage circuit, and the third energy storage circuit are configured to receive their respective switch drive signals respectively, wherein the switch drive signals are used to respectively control the first energy storage circuit, the second energy storage circuit, and the third energy storage circuit to be turned on or turned off, such that the first energy storage circuit, the second energy storage circuit, and the third energy storage circuit are controlled to are switched between a charge state and a discharge state respectively.

11. The voltage conversion circuit according to claim 10, wherein the third energy storage circuit comprises a third energy store configured to store energy; and
the voltage conversion circuit further comprises a third charge control circuit;
wherein the third charge control circuit is configured to acquire a third voltage across the third energy store and generate a third charge control signal based on the third voltage,
wherein the third charge control signal is used to control the first charge circuit and the second charge circuit to be simultaneously turned on or turned off.

12. The voltage conversion circuit according to claim 11, wherein the first charge control signal comprises a first charge enable signal and a first charge disable signal, wherein the first charge enable signal is used to control the first charge circuit to be turned on, and the first charge disable signal is used to control the first charge circuit to be turned off;
the first charge control circuit is configured to generate the first charge enable signal in response to the first voltage being less than a first predetermined value, and generate the first charge disable signal in response to the first voltage being greater than a second predetermined value;
the second charge control signal comprises a second charge enable signal and a second charge disable signal, wherein the second charge enable signal is used to control the second charge circuit to be turned on, and the second charge disable signal is used to control the second charge circuit to be turned off;
the second charge control circuit is configured to generate the second charge enable signal in response to the second voltage being less than the first predetermined value, and generate the second charge disable signal in response to the second voltage being greater than the second predetermined value;
the third charge control signal comprises a third charge enable signal and a third charge disable signal, wherein the third charge enable signal is used to control the first charge circuit and the second charge circuit to be simultaneously turned on, and the third charge disable signal is used to control the first charge circuit and the second charge circuit to be simultaneously turned off; and
the third charge control circuit is configured to generate the third charge enable signal in response to the third voltage being less than the first predetermined value, and generate the third charge disable signal in response to the third voltage being greater than the second predetermined value;
wherein the first predetermined threshold is less than the second predetermined threshold.

13. The voltage conversion circuit according to claim 12, wherein the first charge circuit comprises a first current source, a first transistor, a second transistor, a third transistor, and a fourth transistor;
wherein a positive terminal of the first current source is electrically connected to a second power supply, a negative terminal of the first current source is electrically connected to a first terminal of the first transistor, a second terminal of the first transistor is electrically connected to a first terminal of the third transistor, a second terminal of the third transistor is grounded, a control terminal of the third transistor is electrically connected to a control terminal of the fourth transistor, a first terminal of the fourth transistor is electrically connected to a second terminal of the first energy store, a second terminal of the fourth transistor is grounded, a first terminal of the second transistor is electrically connected to a second terminal of the first transistor, a second terminal of the second transistor is grounded, a control terminal of the first transistor and a control terminal of the second transistor are both configured to receive the first charge control signal and the third charge control signal; and
the second charge circuit comprises a second current source, a fifth transistor, a sixth transistor, a seventh transistor, and an eighth transistor;
wherein a positive terminal of the second current source is electrically connected to the second power supply, a negative terminal of the second current source is electrically connected to a first terminal of the fifth transistor, a second terminal of the fifth transistor is electrically connected to a first terminal of the seventh transistor, a second terminal of the seventh transistor is grounded, a control terminal of the seventh transistor is electrically connected to a control terminal of the eighth transistor, a first terminal of the eighth transistor is electrically connected to a second terminal of the second energy store, a second terminal of the eighth transistor is grounded, a first terminal of the sixth transistor is electrically connected to a second terminal of the fifth transistor, a second terminal of the sixth transistor is grounded, a control terminal of the fifth transistor and a control terminal of the sixth transistor are both configured to receive the second charge control signal and the third charge control signal.

14. The voltage conversion circuit according to claim 11, wherein the first energy store is a first capacitor, and the first energy storage circuit further comprises a ninth transistor and a tenth transistor, wherein a first terminal of the ninth transistor serves as the first terminal of the first energy storage circuit, a second terminal of the ninth transistor is electrically connected to a first terminal of the first capacitor, a second terminal of the first capacitor serves as a second terminal of the first energy storage circuit, a second terminal of the first capacitor is further electrically connected to a first terminal of the tenth transistor, a second terminal of the tenth transistor is electrically connected to the first power supply, and the second terminal of the first capacitor is further electrically connected to an output terminal of the first charge circuit;
the second energy store is a second capacitor, and the second energy storage circuit further comprises an eleventh transistor, wherein a first terminal of the eleventh transistor is electrically connected to the first terminal of the first capacitor, a second terminal of the eleventh transistor is electrically connected to a first terminal of the second capacitor, and a second terminal of the second capacitor is electrically connected to an output terminal of the second charge circuit; and
the third energy store is a third capacitor, and the third energy storage circuit further comprises a twelfth transistor and a thirteenth transistor, wherein a first terminal of the twelfth transistor is electrically connected to the first terminal of the second capacitor, a second terminal of the twelfth transistor is electrically connected to a first terminal of the third capacitor, a second terminal of the third capacitor is electrically connected to a second terminal of the thirteenth transistor, a first terminal of the thirteenth transistor is electrically connected to the second terminal of the second capacitor, and the first terminal and the third terminal of the third capacitor form an output terminal of the third energy storage circuit;
wherein control terminals of the ninth transistor, the tenth transistor, the eleventh transistor, the twelfth transistor, and the thirteenth transistor are configured to receive their respective switch drive signals respectively, wherein the switch drive signals are respectively used to control the ninth transistor, the tenth transistor, the eleventh transistor, the twelfth transistor, and the thirteenth transistor to be turned on or turned off.

15. The voltage conversion circuit according to claim 14, wherein the first energy storage circuit further comprises a first resistor and a second resistor, wherein the second terminal of the ninth transistor is electrically connected to a first terminal of the first resistor, a second terminal of the first resistor is electrically connected to the first terminal of the first capacitor, the second terminal of the tenth transistor is electrically connected to a first terminal of the second resistor, and a second terminal of the second resistor is electrically connected to the first power supply;
the second energy storage circuit further comprises a third resistor, wherein the first terminal of the eleventh transistor is electrically connected to a first terminal of the third resistor, and a second terminal of the third resistor is electrically connected to the first terminal of the second capacitor; and
the third energy storage circuit further comprises a fourth resistor and a fifth resistor, wherein the second terminal of the twelfth transistor is electrically connected to a first terminal of the fourth resistor, a second terminal of the fourth resistor is electrically connected to the first terminal of the third capacitor, the second terminal of the third capacitor is electrically connected to a first terminal of the fifth resistor, and a second terminal of the fifth resistor is electrically connected to the second terminal of the thirteenth transistor.

16. The voltage conversion circuit according to claim 11, wherein the first charge control circuit comprises a first voltage sampling circuit and a first hysteresis comparator circuit, wherein the first voltage sampling circuit is configured to sample the first voltage across the first energy store, and the first hysteresis comparator circuit is configured to compare the first voltage with a corresponding predetermined value and generate the first charge control signal based on a comparison result thereof;
the second charge control circuit comprises a second voltage sampling circuit and a second hysteresis comparator circuit, wherein the second voltage sampling circuit is configured to sample the second voltage across the second energy storage device, and the second hysteresis comparator circuit is configured to compare the second voltage with a corresponding predetermined value and generate the second charge control signal based on a comparison result thereof; and
the third charge control circuit comprises a third voltage sampling circuit and a third hysteresis comparator circuit, wherein the third voltage sampling circuit is configured to sample the third voltage across the third energy store, and the second hysteresis comparator circuit is configured to compare the second voltage with a corresponding predetermined value and generate the third charge control signal based on a comparison result thereof.

17. The voltage conversion circuit according to claim 16, wherein the first voltage sampling circuit, the second voltage sampling circuit, and the third voltage sampling circuit have a same circuit structure, and the first hysteresis comparator circuit, the second hysteresis comparator circuit, and the third hysteresis comparator circuit have a same circuit structure;
wherein the first voltage sampling circuit comprises a fourteenth transistor, a fifteenth transistor, a sixteenth transistor, a seventeenth transistor, an eighteenth transistor, a nineteenth transistor, and a fifth resistor; wherein
a first terminal of the fourteenth transistor is electrically connected to a first terminal of the first energy store, a second terminal of the fourteenth transistor is electrically connected to a first terminal of the fifteenth transistor, a second terminal of the fifteenth transistor is electrically connected to a first terminal of the sixteenth transistor, a second terminal of the sixteenth transistor is electrically connected to a second terminal of the first energy store, a control terminal and the second terminal of the fourteenth transistor are short-circuited, a control terminal and the second terminal of the fifteenth transistor are short-circuited, and a control terminal and the second terminal of the sixteenth transistor are short-circuited;
a first terminal of the seventeenth transistor is electrically connected to the first terminal of the first energy store, a second terminal of the seventeenth transistor is electrically connected to a first terminal of the fifth resistor, a second terminal of the fifth resistor is electrically connected to a second terminal of the first energy store, and a control terminal and a second terminal of the seventeenth transistor are short-circuited; and
a first terminal of the eighteenth transistor is electrically connected to the first terminal of the seventeenth transistor, a control terminal of the eighteenth transistor is electrically connected to the control terminal of the seventeenth transistor, a second terminal of the eighteenth transistor is electrically connected to a first terminal of the nineteenth transistor, a control terminal of the nineteenth transistor is electrically connected to the control terminal of the sixteenth transistor, and a second terminal of the nineteenth transistor serves as an output terminal of the first voltage sampling circuit; and
the first hysteresis comparator circuit comprises a twentieth transistor, a twenty-first transistor, a twenty-second transistor, a twenty-third transistor, a sixth resistor, a seventh resistor, a fourth capacitor, a comparator, and an inverter; wherein
a first terminal of the twentieth transistor is electrically connected to the output terminal of the first voltage sampling circuit, the first terminal and a control terminal of the twentieth transistor are short-circuited, a second terminal of the twentieth transistor is electrically connected to a first terminal of the twenty-first transistor, the first terminal and a control terminal of the twenty-first transistor are short-circuited, a second terminal of the twenty-first transistor is electrically connected to a first terminal of the twenty-second transistor, the first terminal and a control terminal of the twenty-second transistor are short-circuited, and a second terminal of the twenty-second transistor is grounded;
a first terminal of the sixth resistor is electrically connected to the output terminal of the first voltage sampling circuit, a second terminal of the sixth resistor is electrically connected to a first terminal of the seventh resistor, a second terminal of the seventh resistor is grounded, the first terminal of the sixth resistor is electrically connected to a non-inverting input terminal of the comparator, an inverting input terminal of the comparator is configured to receive a predetermined value, and an output terminal of the comparator serves as an output terminal of the first hysteresis comparator circuit and is configured to output the first charge control signal; and
a first terminal of the fourth capacitor is electrically connected to the non-inverting input terminal of the comparator, a second terminal of the fourth capacitor is grounded, a first terminal of the twenty-third transistor is electrically connected to the first terminal of the seventh resistor, a second terminal of the twenty-third transistor is electrically connected to the second terminal of the seventh resistor, the output terminal of the comparator is electrically connected to an input terminal of the inverter, and an output terminal of the inverter is electrically connected to a control terminal of the twenty-third transistor.

18. The voltage conversion circuit according to claim 17, wherein the first voltage sampling circuit further comprises an eighth resistor and a ninth resistor; wherein
the second terminal of the sixteenth transistor is electrically connected to a first terminal of the eighth resistor, and a second terminal of the eighth resistor is electrically connected to the second terminal of the first energy store; and
the first terminal of the sixth resistor is electrically connected to a first terminal of the ninth resistor, and a second terminal of the ninth resistor is electrically connected to the non-inverting input terminal of the comparator.

19. The voltage conversion circuit according to claim 10, further comprising: an electromagnetic interference eliminating circuit, configured to eliminate electromagnetic interference signals in the first energy storage circuit, the second energy storage circuit, and the third energy storage circuit;
wherein the electromagnetic interference eliminating circuit comprises a first output terminal and a second output terminal, wherein the first output terminal of the electromagnetic interference eliminating circuit is electrically connected to the second terminal of the first energy store, and the second output terminal of the electromagnetic interference eliminating circuit is electrically connected to the second terminal of the second energy store.

20. The voltage conversion circuit according to claim 19, wherein the electromagnetic interference eliminating circuit comprises a twenty-fourth transistor, a twenty-fifth transistor, a twenty-sixth transistor, a twenty-seventh transistor, a twenty-eighth transistor, a twenty-ninth transistor, a thirtieth transistor, a thirty-first transistor, a third current source, and a fourth current source; wherein
a positive terminal of the third current source is electrically connected to the second power supply, a negative terminal of the third current source is electrically connected to a first terminal of the twenty-fourth transistor, a second terminal of the twenty-fourth transistor is electrically connected to a first terminal of the twenty-fifth transistor, the first terminal and a control terminal of the twenty-fifth transistor are short-circuited, a second terminal of the twenty-fifth transistor is grounded, a first terminal of the twenty-sixth transistor serves as the first output terminal of the electromagnetic interference eliminating circuit, a second terminal of the twenty-sixth transistor is grounded, a control terminal of the twenty-sixth transistor is electrically connected to a control terminal of the twenty-fifth transistor, a first terminal of the twenty-seventh transistor is electrically connected to the second terminal of the twenty-fourth transistor, a second terminal of the twenty-seventh transistor is grounded, and a control terminal of the twenty-fourth transistor and a control terminal of twenty-seventh transistor are both configured to receive a fourth charge control signal, wherein the fourth charge control signal is used to control the twenty-fourth transistor and the twenty-seventh transistor to be turned on or turned off simultaneously; and
a positive terminal of the fourth current source is electrically connected to the second power supply, a negative terminal of the fourth current source is electrically connected to a first terminal of the twenty-eighth transistor, a second terminal of the twenty-eighth transistor is electrically connected to a first terminal of the twenty-ninth transistor, the first terminal and a control terminal of the twenty-ninth transistor are short-circuited, a second terminal of the twenty-ninth transistor is grounded, a first terminal of the thirty-first transistor serves as the second output terminal of the electromagnetic interference eliminating circuit, a second terminal of the thirty-first transistor is grounded, a control terminal of the thirty-first transistor is electrically connected to the control terminal of the twenty-ninth transistor, a first terminal of the thirtieth transistor is electrically connected to the second terminal of the twenty-eighth transistor, a second terminal of the thirtieth transistor is grounded, and a control terminal of the twenty-eighth transistor and a control terminal of the thirtieth transistor are both configured to receive a fifth charge control signal, wherein the fifth charge control signal is used to control the twenty-eighth transistor and the thirtieth transistor to be simultaneously turned on or turned off.

21. A voltage conversion circuit, comprising: a first energy storage circuit, a second energy storage circuit, a third energy storage circuit, a first charge circuit, a second charge circuit, and a first feedback control circuit; wherein
the first energy storage circuit, the second energy storage circuit, and the third energy storage circuit are connected in parallel, a first terminal of the first energy storage circuit is electrically connected to a power supply, and two terminals of the third energy storage circuit are electrically connected to a load;
the first charge circuit is configured to supply a first charge current to the first energy storage circuit, and the second charge circuit is configured to supply a second charge current to the second energy storage circuit;
the first charge circuit and the second charge circuit are configured to receive their respective switch control signals respectively, wherein the switch control signals are used to control the first charge circuit and the second charge circuit to be turned on or turned off respectively; and the first energy storage circuit, the second energy storage circuit, and the third energy storage circuit are configured to receive their respective switch drive signals respectively, wherein the switch drive signals are used to respectively control the first energy storage circuit, the second energy storage circuit, and the third energy storage circuit to be turned on or turned off, such that the first energy storage circuit, the second energy storage circuit, and the third energy storage circuit are respectively controlled to are switched between a charge state and a discharge state;
the first feedback control circuit is configured to acquire a first voltage at an output terminal of the third energy storage circuit in a case where the third energy storage circuit is in a charge state, and adjust magnitudes of the first charge current and the second charge current based on the first voltage; and
the first feedback control circuit comprises a first zero-order hold, configured to maintain a voltage at the output terminal of the third energy storage circuit to be the first voltage in a case where the third energy storage circuit is in a discharge state.

22. The voltage conversion circuit according to claim 21, wherein the third energy storage circuit comprises a compensation resistor and a third capacitor; wherein
a first terminal of the second energy storage circuit is electrically connected to a first terminal of the compensation resistor;
a second terminal of the compensation resistor is electrically connected to a first terminal of the third capacitor, and a second terminal of the third capacitor is electrically connected to a second terminal of the second energy storage circuit; and
the first feedback control circuit is configured to acquire a voltage between the first terminal of the compensation resistor and the second terminal of the third capacitor as the first voltage.

23. The voltage conversion circuit according to claim 21, wherein each of the first energy storage circuit, the second energy storage circuit, the third energy storage circuit, the first charge circuit, the second charge circuit comprises at least one transistor;
wherein a transistor, which is one of the at least one transistor, is configured to receive a corresponding switch control signal, wherein the switch control signal is used to control the transistor to be turned on or turned off, such that an energy storage circuit comprising the transistor is controlled to be turned on or turned off.

24. The voltage conversion circuit according to claim 23, wherein the first charge circuit comprises a first transistor, a second transistor, and a third transistor;
wherein a first terminal of the first transistor is configured to receive a first current control signal, wherein the first current control signal is used to control the first charge circuit to adjust a magnitude of the first charge current; a second terminal of the first transistor is grounded, the first terminal and a control terminal of the first transistor are short-circuited, and the control terminal of the first transistor is electrically connected to a control terminal of the second transistor; a first terminal of the second transistor is electrically connected to a second terminal of the third transistor, and a second terminal of the second transistor is grounded; and a first terminal of the third transistor is electrically connected to a second terminal of the first energy storage circuit, and the first terminal of the first energy storage circuit is configured to be connected to the power supply; and
the second charge circuit comprises a fourth transistor, a fifth transistor and a sixth transistor; wherein
a first terminal of the fourth transistor is configured to receive a second current control signal, wherein the second current control signal is used to control the second charge circuit to adjust a magnitude of the second charge current; a second terminal of the fourth transistor is grounded, the first terminal and a control terminal of the fourth transistor are short-circuited, and the control terminal of the fourth transistor is electrically connected to a control terminal of the fifth transistor; a second terminal of the fifth transistor is grounded, a first terminal of the fifth transistor is electrically connected to a second terminal of the sixth transistor, and a first terminal of the sixth transistor is electrically connected to one terminal of the second energy storage circuit;
a control terminal of the third transistor and a control terminal of the sixth transistor are configured to receive their respective switch control signals respectively, wherein the switch control signals are respectively used to control the third transistor and the sixth transistor to be turned on or turned off; and
a withstand voltage of the third transistor is greater than withstand voltages of the first transistor and the second transistor, and a withstand voltage of the sixth transistor is greater than withstand voltages of the fourth transistor and the fifth transistor.

25. The voltage conversion circuit according to claim 21, wherein the first feedback control circuit further comprises a first voltage sampling circuit and a first error amplifier; wherein
the first voltage sampling circuit is configured to acquire the first voltage at the output terminal of the third energy storage circuit in a case where the third energy storage circuit is in the charge state;
the first zero-order hold is configured to maintain the first voltage output by the first energy storage circuit in a case where the third energy storage circuit is in the discharge state; and
the first error amplifier is configured to compare the first voltage with a first reference voltage to obtain a comparison result, and generate a first current control signal and a second current control signal based on the comparison result;
wherein the first current control signal is used to control the first charge circuit to adjust a magnitude of the first charge current, and the second current control signal is used to control the second charge circuit to adjust a magnitude of the second charge voltage.

26. The voltage conversion circuit according to claim 22, wherein the first energy storage circuit comprises a first capacitor, and the second energy storage circuit comprises a second capacitor;
the first energy storage circuit further comprises a seventh transistor and an eighth transistor, wherein a first terminal of the seventh transistor serves as the first terminal of the first energy storage circuit, a second terminal of the seventh transistor is electrically connected to a first terminal of the first capacitor, a second terminal of the first capacitor serves as a second terminal of the first energy storage circuit, a second terminal of the first capacitor is further electrically connected to a first terminal of the seventh transistor, and a second terminal of the eighth transistor is electrically connected to the first power supply;
the second energy storage circuit further comprises a ninth transistor, wherein the first terminal of the ninth transistor serves as the first terminal of the second energy storage circuit, the first terminal of the second energy storage circuit is electrically connected to the first terminal of the first capacitor, a second terminal of the ninth transistor is electrically connected to a first terminal of the second capacitor, and a second terminal of the second capacitor serves as the second terminal of the second energy storage circuit; and
the third energy storage circuit further comprises a tenth transistor and an eleventh transistor, wherein a first terminal of the tenth transistor is electrically connected to the first terminal of the second capacitor, a second terminal of the tenth transistor is electrically connected to the first terminal of the third capacitor, the second terminal of the third capacitor is electrically connected to a second terminal of the eleventh transistor, a first terminal of the eleventh transistor is electrically connected to the second terminal of the second capacitor, and the first terminal and the second terminal of the third capacitor form an output terminal of the third energy storage circuit;
wherein a control terminal of the seventh transistor, a control terminal of the eighth transistor, a control terminal of the ninth transistor, a control terminal of the tenth transistor, and a control terminal of the eleventh transistor are configured to receive their respective switch drive signals respectively, wherein the switch drive signals are respectively used to control the seventh transistor, the eighth transistor, the ninth transistor, the tenth transistor, and the eleventh transistor to be turned on or turned off.
